(19) United States
(12) Patent Application Publication
(10) Pub. No.: US 2026/0057741 A1
(43) Pub. Date: Feb. 26, 2026

(54) GAMING SYSTEM AND METHOD OF GAMING PROVIDING MULTIPLE RANDOM CHANCES TO TRIGGER A METAMORPHIC

(71) Applicant: Aristocrat Technologies, Inc., Las Vegas, NV (US)

(72) Inventors: Gary Penacho, Henderson, NV (US); Allon Englman, Las Vegas, NV (US)

(21) Appl. No.: 18/815,443

(22) Filed: Aug. 26, 2024

(51) Int. Cl. G07F 17/32; G07F 17/34

(52) U.S. Cl. CPC G07F 17/3267; G07F 17/3211; G07F 17/34

(57) ABSTRACT

A system for electronic gaming displays a plurality of symbols for play of an electronic game, the symbols including at least one multi-triggering symbol associated with a plurality of chances to trigger a feature game by randomly determining that one chance of the chances causes triggering of the feature game. Upon triggering a plurality of meters for the feature game are displayed based upon one chance causing the feature game to be triggered, and for each remaining chance, a meter of the plurality of meters is increased resulting in an adjusted plurality of meters. A reel set for the feature game is generated based upon the adjusted plurality of meters and includes a plurality of reels, each including a plurality of symbols that are determined at least in part based on a final state of the adjusted plurality of meters. The feature game is initiated using the generated reel set.

### TECHNICAL FIELD

The field of disclosure relates generally to electronic gaming, and more specifically, to electronic gaming systems and methods that include displaying a multi-triggering symbol during game play wherein the multi-triggering symbols provide one or more random chances to trigger a metamorphic and/or other aspects within the electronic game.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a system for electronic gaming includes at least one memory device storing instructions and at least one processor in communication with the at least one memory device, wherein the instructions, when executed by the at least one processor, cause the at least one processor to: (i) cause display of a plurality of symbols for a play of an electronic game, the plurality of symbols including at least one multi-triggering symbol associated with a plurality of chances to trigger a feature game; (ii) randomly determine that one chance of the plurality of chances causes the feature game to be triggered; (iii) cause display of a plurality of meters for the feature game based upon the one chance causing the feature game to be triggered; (iv) for each remaining chance of the plurality of chances, cause a meter of the plurality of meters for the feature game to increase resulting in an adjusted plurality of meters; (v) generate a reel set for the feature game based upon the adjusted plurality of meters, the reel set including a plurality of reels each including a plurality of symbols that are determined at least in part based on a final state of the adjusted plurality of meters; and (vi) cause the feature game to be initiated using the generated reel set.

In another aspect, a method for electronic gaming, the method including, via at least one memory device having instructions stored thereon and at least one processor in communication with the at least one memory device, the execution of the instructions by the at least one processor: (i) causing display of a plurality of symbols for a play of an electronic game, the plurality of symbols including at least one multi-triggering symbol associated with a plurality of chances to trigger a feature game; (ii) randomly determining that one chance of the plurality of chances causes the feature game to be triggered; (iii) causing display of a plurality of meters for the feature game based upon the one chance causing the feature game to be triggered; (iv) for each remaining chance of the plurality of chances, causing a meter of the plurality of meters for the feature game to increase resulting in an adjusted plurality of meters; (v) generating a reel set for the feature game based upon the adjusted plurality of meters, the reel set including a plurality of reels each including a plurality of symbols that are determined at least in part based on a final state of the adjusted plurality of meters; and (vi) causing the feature game to be initiated using the generated reel set.

In yet another aspect, one or more non-transitory computer-readable media containing instructions thereon for controlling one or more electronic gaming devices, which when executed by one or more processors of the one or more electronic gaming devices, cause the one or more processors to: (i) cause display of a plurality of symbols for a play of an electronic game, the plurality of symbols including at least one multi-triggering symbol associated with a plurality of chances to trigger a feature game; (ii) randomly determine that one chance of the plurality of chances causes the feature game to be triggered; (iii) cause display of a plurality of meters for the feature game based upon the one chance causing the feature game to be triggered; (iv) for each remaining chance of the plurality of chances, cause a meter of the plurality of meters for the feature game to increase resulting in an adjusted plurality of meters; (v) generate a reel set for the feature game based upon the adjusted plurality of meters, the reel set including a plurality of reels each including a plurality of symbols that are determined at least in part based on a final state of the adjusted plurality of meters; and (vi) cause the feature game to be initiated using the generated reel set.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a flowchart illustrating an exemplary process for electronic gaming using a multi-triggering symbol according to an embodiment of the present disclosure.

FIG. 5 is a flowchart illustrating an exemplary process for electronic gaming using a multi-triggering symbol to upgrade metamorphic features according to an embodiment of the present disclosure.

FIGS. 6A-6L depict an exemplary game interface according to an embodiment of the present disclosure.

FIGS. 7A-7G depict another exemplary game interface according to an embodiment of the present disclosure.

FIG. 8 is a flowchart illustrating an exemplary process for electronic gaming using a multi-triggering symbol and multiple reel sets according to an embodiment of the present disclosure.

FIGS. 9A-9G depict another exemplary game interface according to an embodiment of the present disclosure.

FIGS. 10A-10G depict another exemplary game interface according to an embodiment of the present disclosure.

FIGS. 11A and 11B depict another exemplary game interface according to an embodiment of the present disclosure.

### DETAILED DESCRIPTION

Described herein are electronic gaming systems and methods that include using multi-triggering symbols that are displayed during game play within a symbol matrix to trigger multiple metamorphic features (e.g., fireballs) in the electronic game. As described herein, the multi-triggering symbol may be a single symbol displayed within a single display position on the matrix that visually indicates that it is triggering one or more metamorphic features. The multi-triggering symbol has dual purposes in the base game and feature game with which it triggers. A multi-triggering symbol which lands on one of the reels in the base game provides multiple randomly-based chances to trigger the feature game and, once the feature game has been triggered (e.g., associated with the initial metamorphic, such as a bonus meter), the multi-triggering symbol uses any leftover “chances” (e.g., metamorphic features, such as fireballs) to upgrade one of four revealed bonus meters prior to launching the feature game.

A random determination may be made for each metamorphic feature (e.g., fireball) in the base game as to whether the feature game will be triggered. Once the feature game is triggered, a random determination may be made for each “leftover” metamorphic feature as to which now-displayed bonus meter the metamorphic feature will cause to increase.

Bonus meters for the feature game may include a free games meter (e.g., associated with a number of free spins to be provided in the feature game), a feature symbols meter (e.g., associated with a number of feature symbols added to the reels for the feature game), a wild symbols meter (e.g., associated with a number of wild symbols added to the reels for the feature game), and a jackpots unlocked meter (e.g., associated with a number of jackpots unlocked as eligible to be provided in the feature game).

Visual changes in the game display may indicate to a user that a metamorphic (e.g., bonus meter associated with a feature game being triggered) and corresponding feature game are activated. Various animations may be displayed to indicate that the game feature was triggered and/or which features (e.g., associated with the meters described herein) are activated and/or increased.

Metamorphic features may be triggered based on a base game outcome. For example, a trigger symbol may be displayed in the game outcome, and in response to the trigger symbol being displayed, a random determination may be made (e.g., using a random number generator (RNG) to determine to activate a metamorphic that is associated with the trigger symbol (e.g., the bonus meter)). In some implementations, one type of triggering symbol, referred to herein as a “multi-triggering symbol,” may be associated with and potentially trigger a metamorphic such as the bonus meter and one of the plurality of features that may be applied in the feature game.

A technical problem exists in enabling gaming devices to improve an ability to control randomly landing triggering symbols within a single game outcome to trigger multiple features. In a conventional game with multiple features, the game may land a triggering symbol that is associated with only one of the features. For example, a game may have a free games feature. To have an opportunity to trigger the free games feature, the free games triggering symbol needs to land. If a given triggering symbol lands, an RNG call may be performed to determine whether the corresponding feature is triggered.

As the number of features presented within a game starts to increase, for example, to four, five, or six metamorphic features, having a game outcome that lands all the different triggering symbols becomes more difficult (e.g., lower probability) given the random nature of the gaming environment. As an example, if a game has six different features that correspond to six different triggering symbols, the game will need to generate an outcome that lands all six triggering symbols to provide a player a chance/opportunity to trigger all six features. The probability to trigger all six features is even lower since landing a triggering symbol does not necessarily guarantee triggering the feature. In current games, given the random nature of generating a game outcome, the game designer is limited on how to go about controlling the rates of providing a player the opportunity to the trigger the features.

The disclosed system is technically rooted in gaming technology that generates opportunities to trigger multiple features based on a single multi-triggering symbol being provided. In one implementation, the game may land a multi-triggering symbol that has ability to be applied to both the base game and a feature game of the overall electronic game, and other prize features which it may trigger. A multi-trigger symbol which lands on one of the reels in the base game provides multiple randomly-based chances to trigger the metamorphic (initial metamorphic, e.g., a bonus meter) to enter the feature game, and once the feature game has been triggered, the multi-trigger symbol uses any leftover “chances” provided by the metamorphic features to upgrade/enhance one of a variety (e.g., four) revealed prize meters prior to launching the feature game.

The adjustments to the feature game (e.g., the reels to be spun for the feature game, the number of plays of the feature game, the number of jackpots that are eligible to be provided for the feature game) associated with the revealed prize meters are thus set before the free spins feature of the feature game begins, and are able to be won during the free spins feature of the feature game.

The technical problems addressed herein include: (i) inability for known electronic games that include multiple features to simultaneously trigger a metamorphic and a feature game and one or more of a plurality of features within the feature game; (ii) inability for known electronic games that include multiple features to simultaneously trigger more than one of the features while maintaining return to player (RTP); and/or (iii) limited degrees of randomness that may be used to determine which features are provided in known electronic games.

The resulting technical effect and/or technical benefits achieved herein include at least one of: (i) ability in electronic games to include displaying a triggering symbol with a predefined association with single and/or multiple metamorphic features and can be associated with a base game and a feature game of the same overall electronic game; (ii) ability in electronic games that include multiple features to simultaneously trigger more than one of the features while maintaining return to player (RTP) with single and/or multiple metamorphic features; (iii) providing more degrees of variability and randomness in determining which features are provided in electronic games, without the need for additional computer resources such as computer processing and/or memory resources; and/or (iv) providing additional information and gameplay features to a user (e.g., player) of the electronic game within a limited amount of display space via an enhanced graphical user interface (GUI) of the game, including providing, via the GUI, additional information to the user during gameplay to apprise the user of the status of triggering a feature game and enhancement of bonus prizes within the feature game.

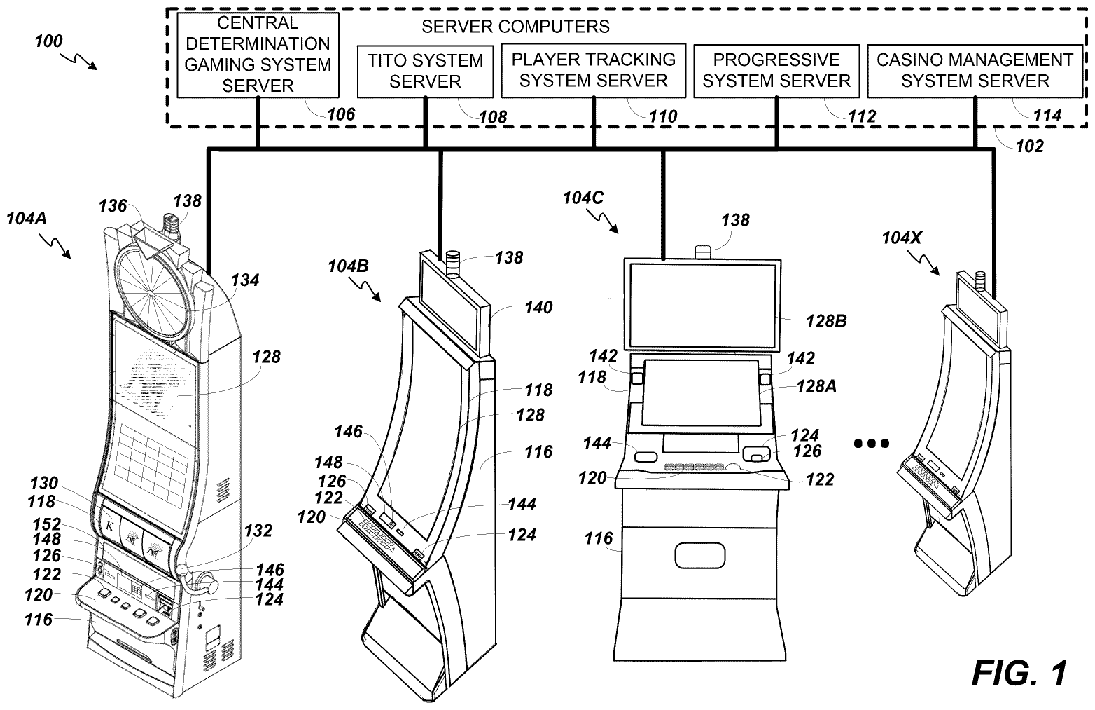

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 including a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out”printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.01, $0.02, $0.05, or $0.10), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

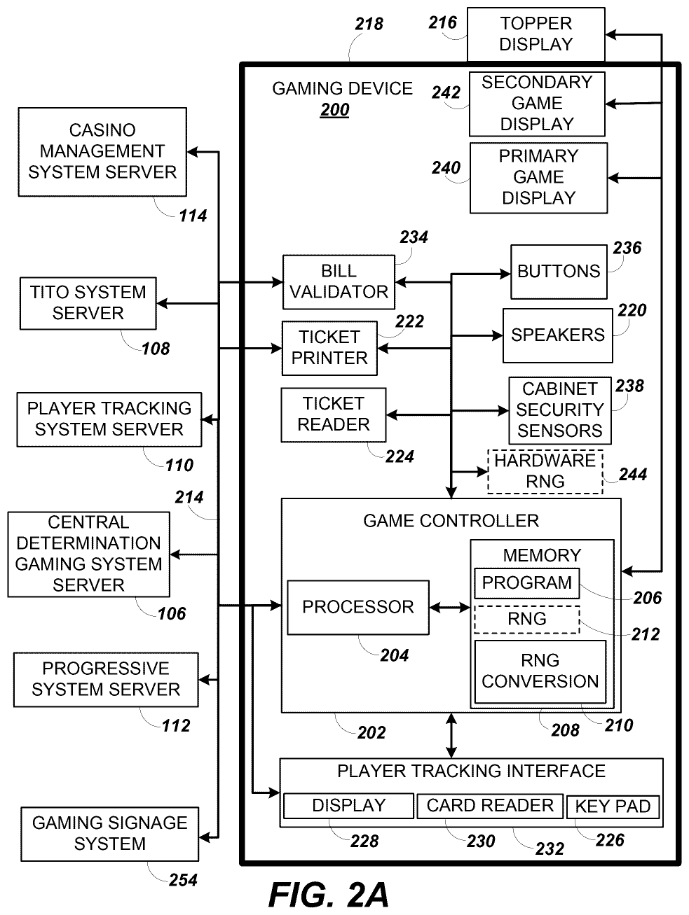

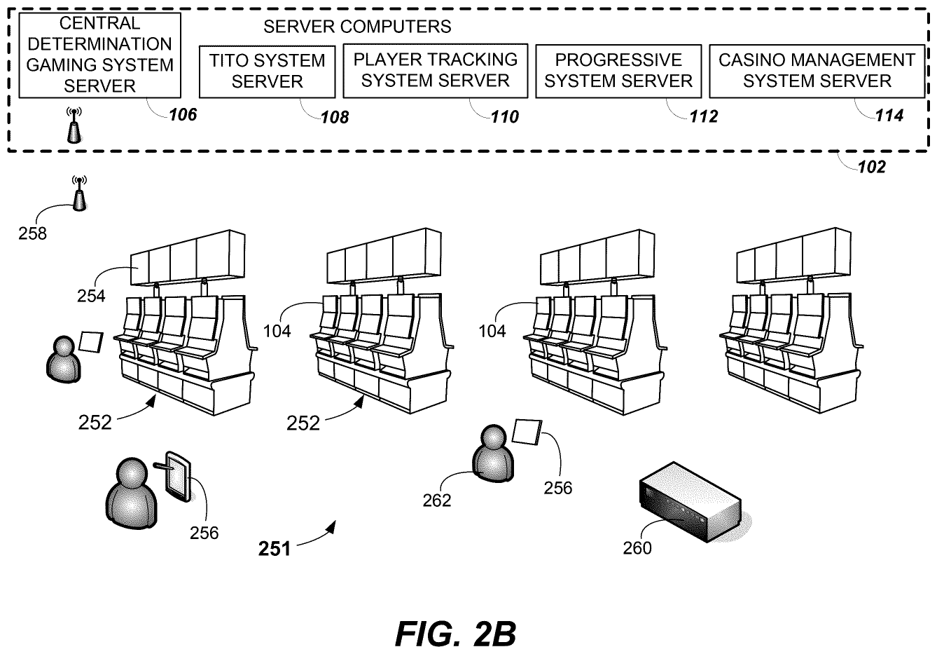

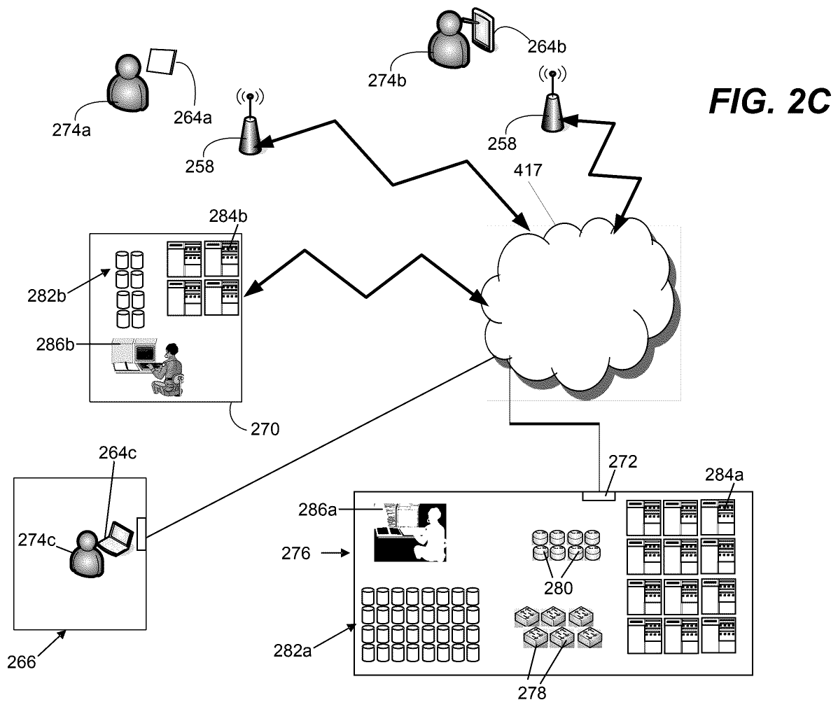

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts. Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more user interfaces (UIs), the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104A-104X. In this example, each bank 252 of EGMs 104A-104X includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104A-104X, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding number of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real (e.g., physical) button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

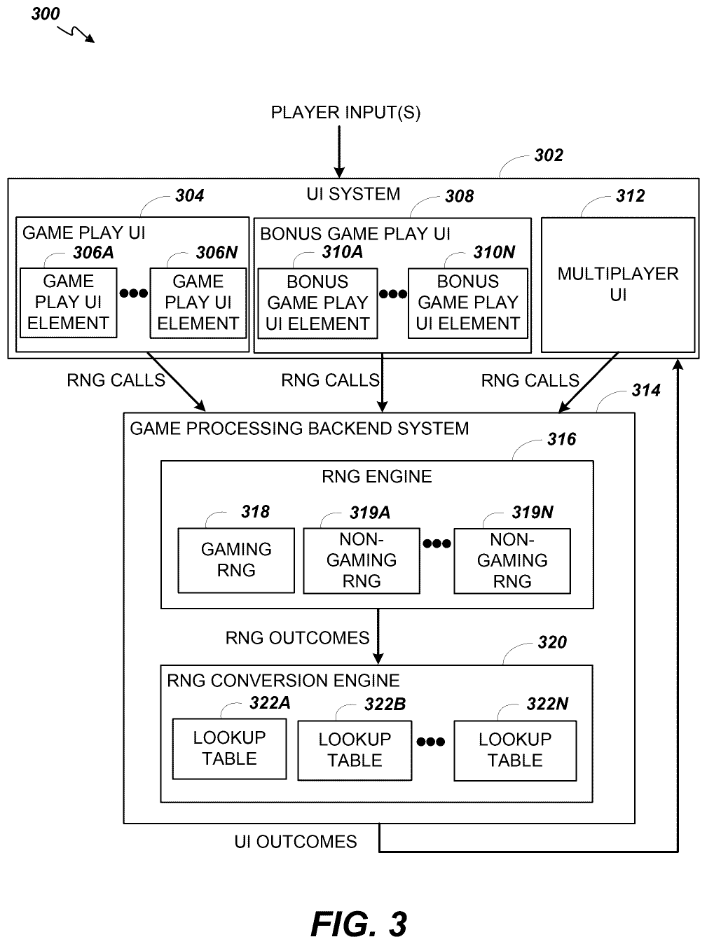

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

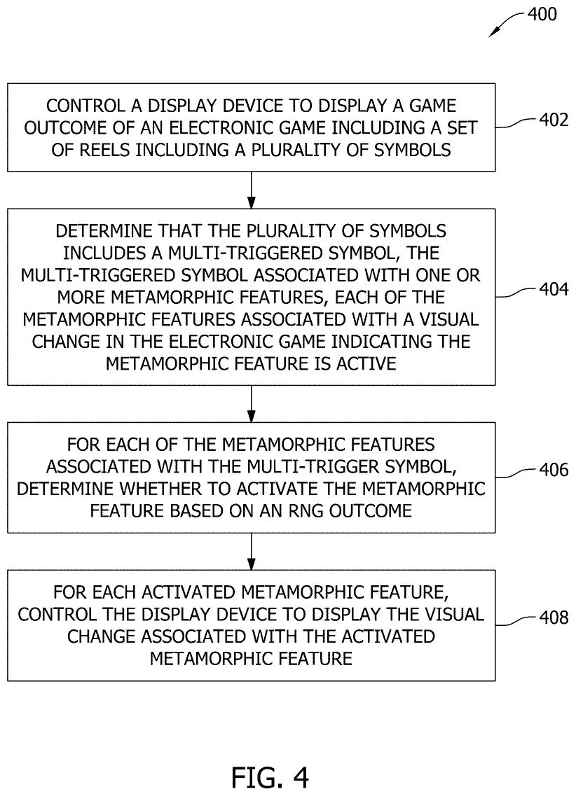

FIG. 4 is a flowchart illustrating an exemplary process 400 for electronic gaming using a multi-triggering symbol that may trigger multiple metamorphic features (e.g., fireballs) and is usable in a base game and a feature game of the same overall game. Process 400 may be performed by system 100 (shown in FIG. 1), for example, using one or more server computers 102, gaming devices 104, and/or mobile gaming devices 256 (shown in FIG. 2).

In the exemplary embodiment, process 400 may include controlling 402 a display device (e.g., game displays 240 and 242) to display a game outcome of the electronic game. The game outcome may include a set of reels including a plurality of symbols, for example, displayed in respective matrix positions of the reels. The game outcome may be determined randomly, for example, by performing a lookup using one or more pay tables based on one or more RNG outcomes.

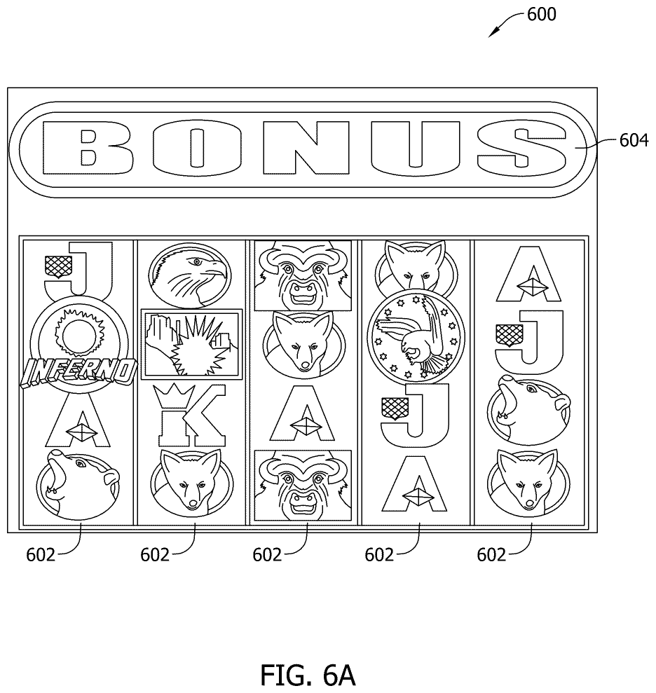

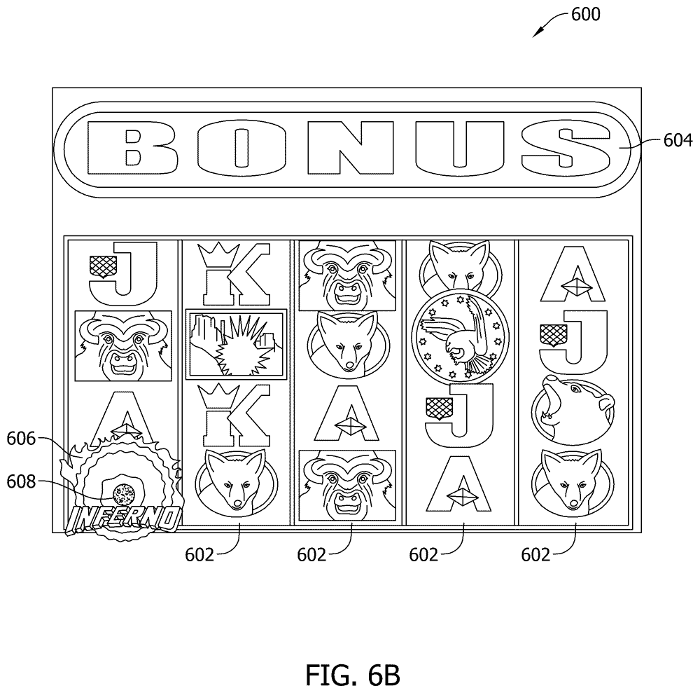

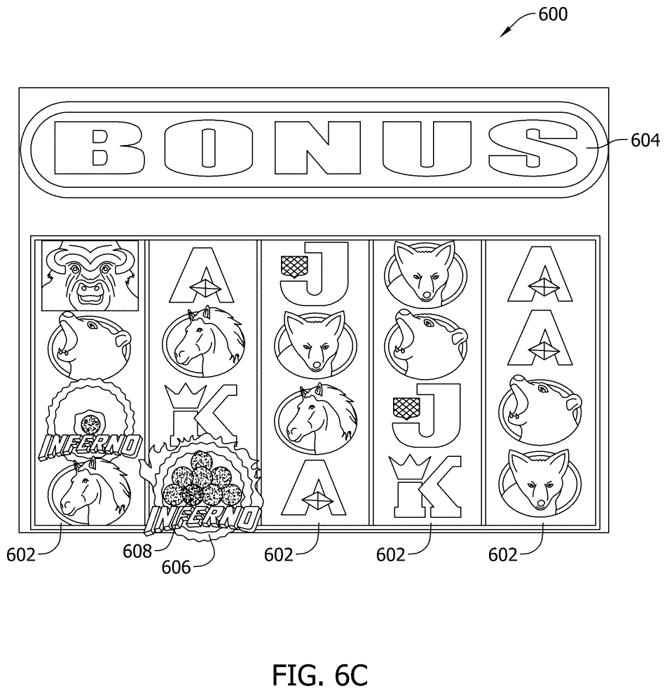

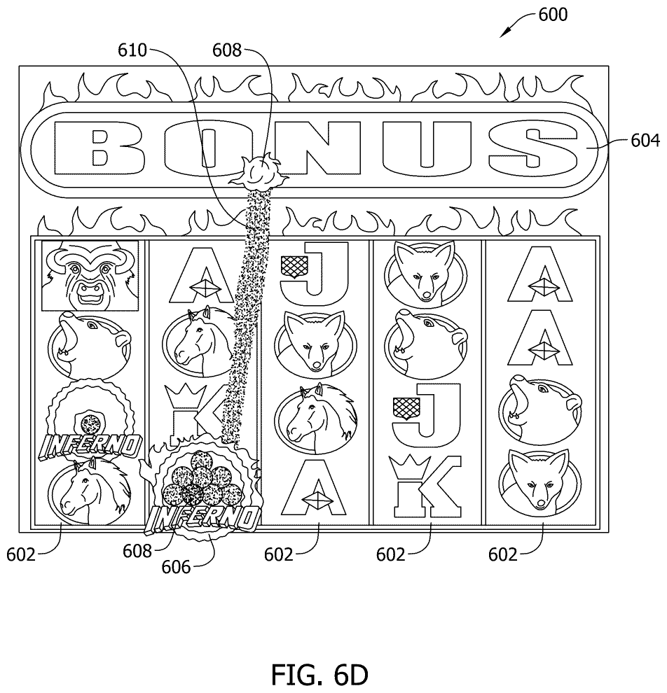

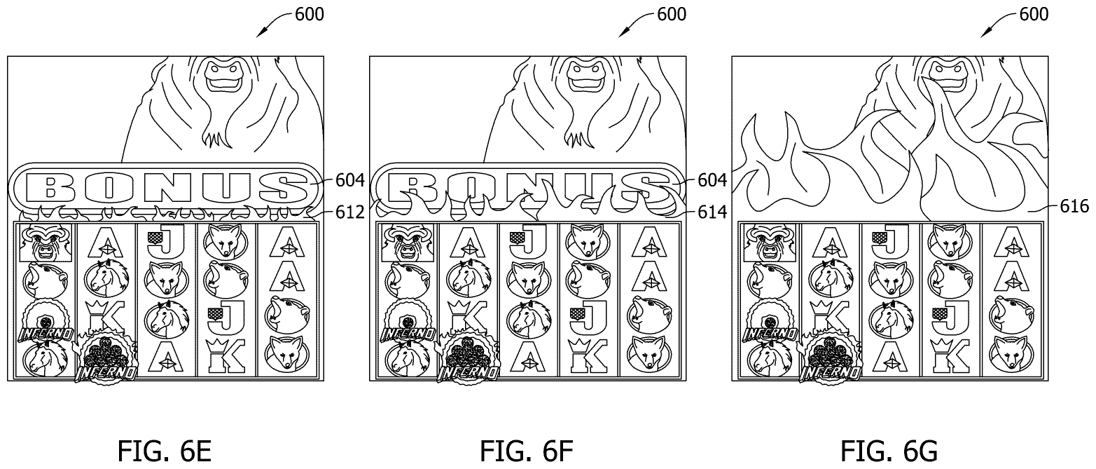

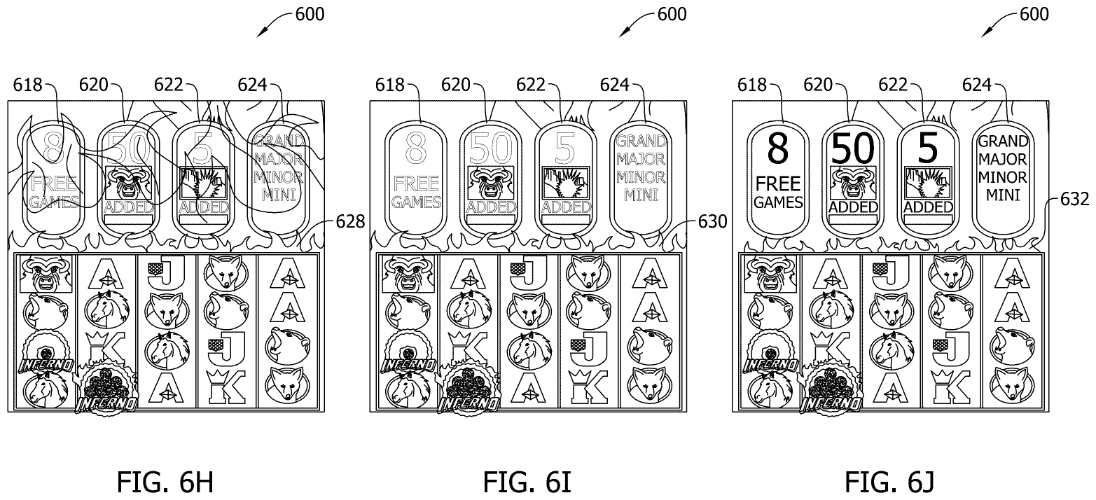

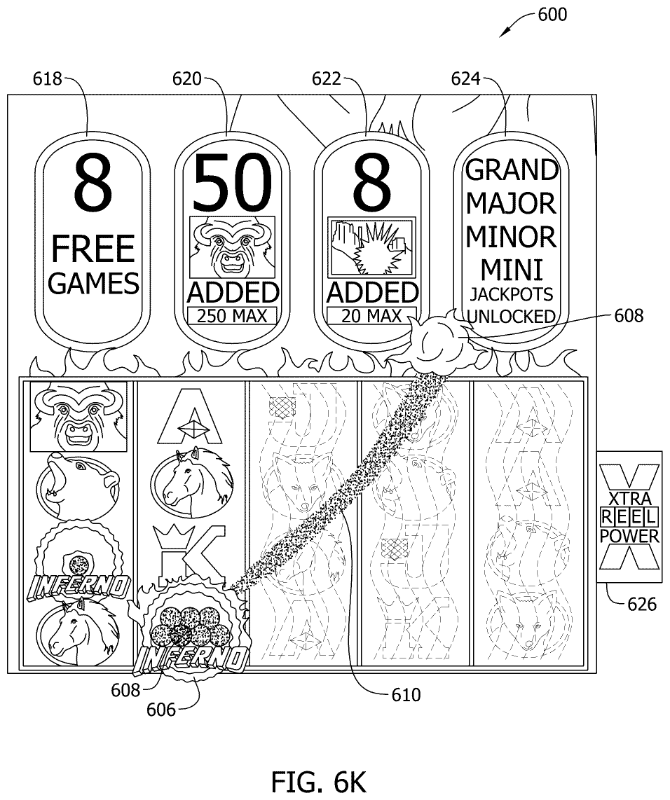

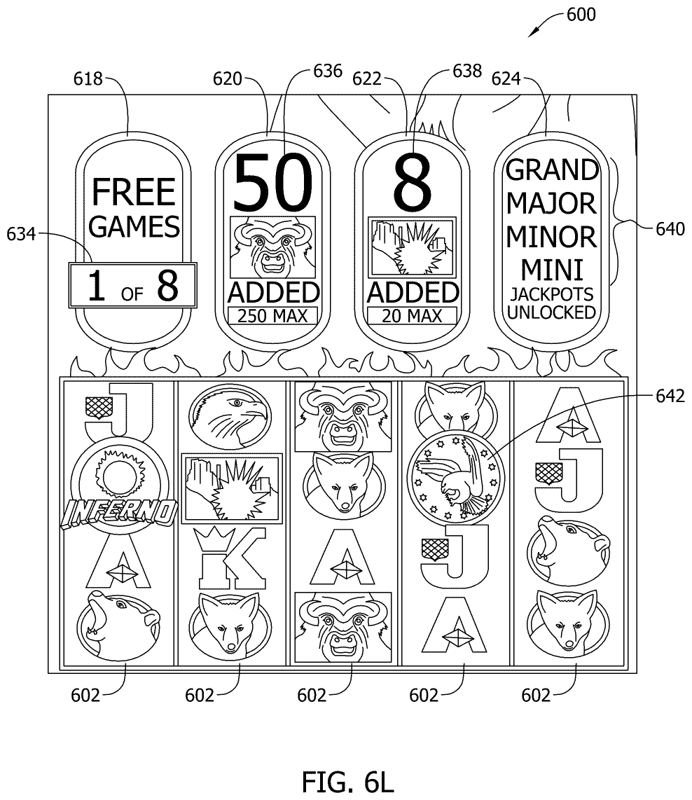

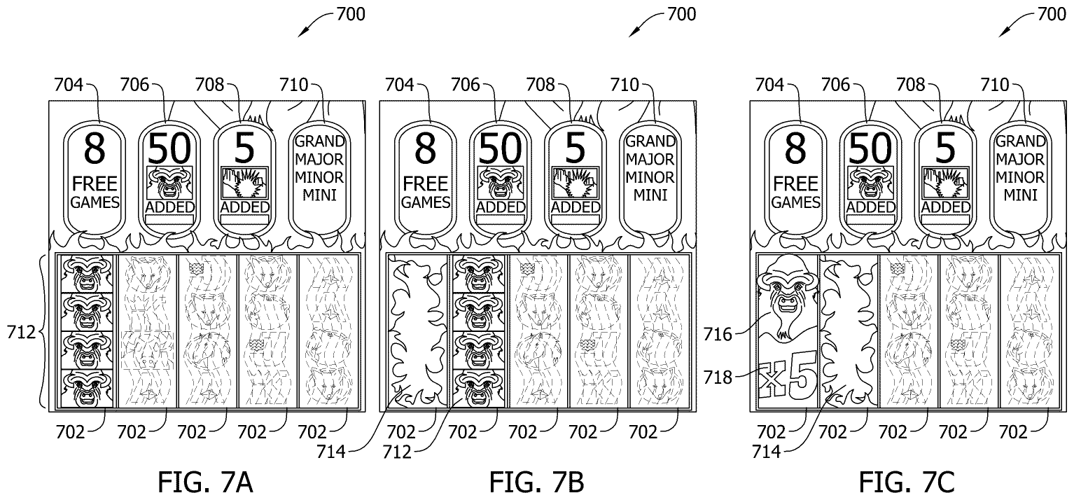

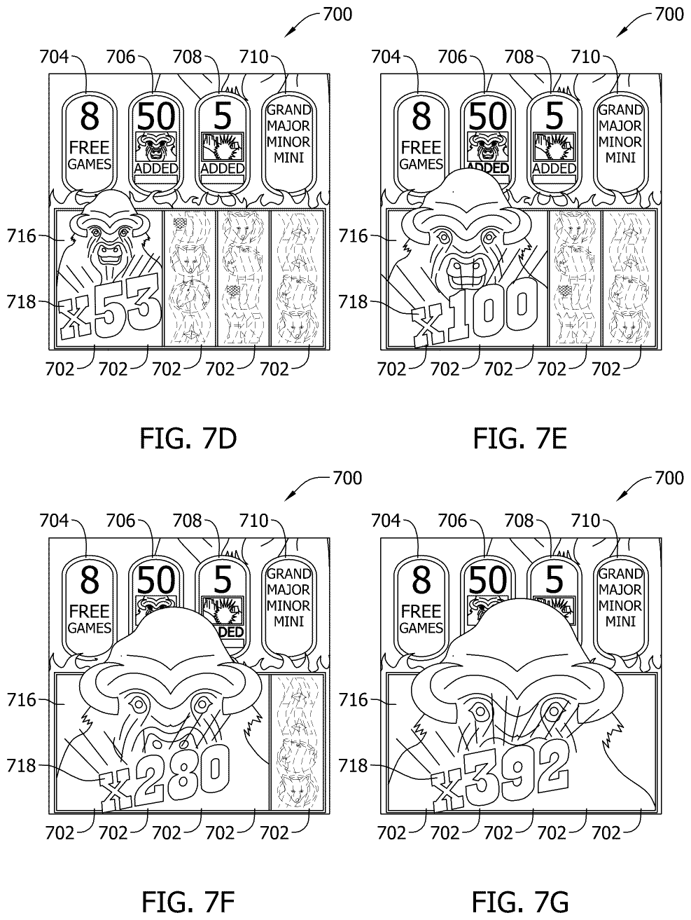

In the exemplary embodiment, the electronic game may include one or more metamorphic features. When a metamorphic feature is activated (e.g., fireball is applied to a metamorphic of meter), a certain game mechanic and audio/visual change in the game display may be triggered. The visual change may indicate to a user that the metamorphic feature and corresponding game mechanic are activated. Examples of usage of metamorphic features may include using metamorphic features to trigger eligibility for jackpots or prizes, eligibility for bonus features, multipliers, free spins, and/or other game mechanics that may be added to gameplay of the electronic game. Examples of audible and visual changes may include sound effects, overlays of graphics and/or animations, and/or changes to a background of the game display (e.g., changing images, changing colors, highlighting portions of the display, graying-out portions of the display). Some examples of visual changes are shown in FIGS. 6A-6L and 7A-7G, which are described in further detail below.

In the exemplary embodiment, activation of these metamorphic features may be triggered in part by an appearance of a corresponding triggering symbol in the game outcome. For example, when the game outcome includes a triggering symbol associated with a certain number of metamorphic features, a random determination may be made (e.g., based on one or more RNG outcomes) to determine whether a feature game will be activated and/or which feature in the feature game will be upgraded.

As described in further detail below, the triggering symbols that can be displayed may include multi-triggering symbols that are associated with one or more metamorphic features, provide multiple random chances to trigger features, and that may trigger features in both a base game and a feature game via just one multi-triggering symbol. Multi-triggering symbols may include a display aspect (e.g., a number of graphics equating to a fixed number of chances) associated with triggering features.

In the exemplary embodiment, process 400 may further include determining 404 that the plurality of symbols of the displayed game outcome includes a multi-triggering symbol. The multi-triggering symbol may be associated with at least two game modes, which, as described above, may each by associated with a corresponding visual change in the electronic game indicating the metamorphic is active. In some embodiments, one of the multi-triggering symbols may be associated with one or more metamorphic features, with a possibility of different multi-triggering symbols with different numbers of associated metamorphic features appearing.

In the exemplary embodiment, process 400 may further include, for each of the metamorphic features associated with the multi-triggering symbol that is displayed, determining 406 whether to activate the metamorphic (e.g., bonus meter) based on a respective RNG outcome. For example, a displayed multi-triggering symbol may be associated with four features of a feature game: a free game (e.g., free spins) meter, a feature symbol meter, a wild symbol meter, and a jackpot meter. For each of these meters, a separate RNG call may be performed to determine if the corresponding feature becomes activated. Thus, when the multi-triggering symbol appears, it may be possible that one, two, three, four or none of the features of the feature game associated with the multi-triggering symbol are activated or are activated upon execution of a triggering function of the multi-triggering symbol.

In some embodiments, one or more of the metamorphic features may have a different probability of being activated. For example, free spins may have the highest probability, jackpot may have the lowest probability, and a wild symbol may have an intermediate probability. To achieve this, each RNG call to determine if the corresponding metamorphic feature may be evaluated using a different pay table or series of lookup values associated with the metamorphic feature.

In the exemplary embodiment, process 400 may further include, for each activated metamorphic feature, controlling 408 the display device to display the visual change associated with the activated feature. As described above, examples of such visual changes may include overlays and/or changes to a background of the game display (e.g., changing images, changing colors, highlighting/graying-out portions of the display), each of which may be associated with a particular feature. In cases where multiple features are activated, multiple visual changes may be implemented. Once activated, the feature may remain activated for a certain, predefined period (e.g., a number of turns or number of free spins, an amount of time, and/or until a game session is ended). The visual change and game mechanic associated with the metamorphic feature may remain present during this period.

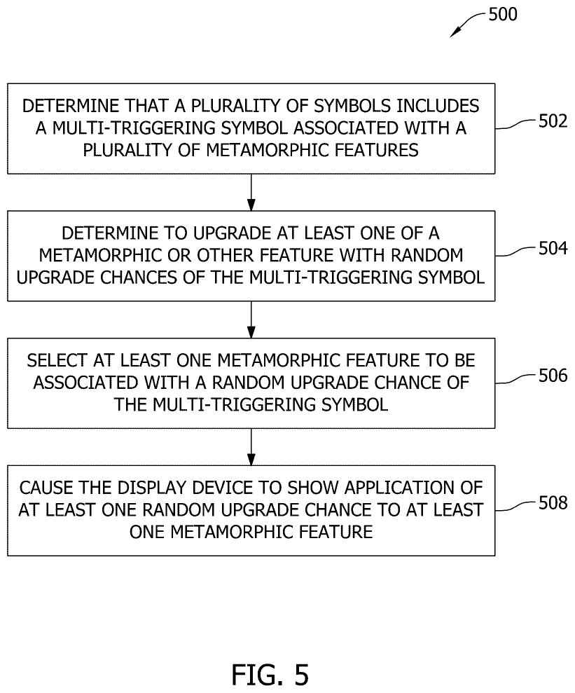

FIG. 5 is a flowchart illustrating an exemplary process 500 for electronic gaming using a multi-triggering symbol that may trigger multiple features. Process 500 may be performed by system 100 (shown in FIG. 1), for example, using one or more server computers 102, gaming devices 104, and/or mobile gaming devices 256 (shown in FIG. 2), and in conjunction with process 400 (shown in FIG. 4).

In the exemplary embodiment, process 500 may include determining 502 that a multi-triggering symbol is present amongst a plurality of symbols in a reel matrix of the game, and that the multi-triggering symbol can be associated with a metamorphic (e.g., in a base game) and other features (e.g., in a feature game) in order to upgrade, convert, or enhance at least one of the metamorphic and/or the features via application of a random upgrade chance associated with the multi-triggering symbol.

In the exemplary embodiment, process 500 may further include, for each metamorphic feature, determining 504 to upgrade at least one of a metamorphic (e.g., bonus meter) and/or feature (e.g., prize meter) of a feature game with at least one random upgrade chance associated with the multi-trigger symbol.

In the exemplary embodiment, process 500 may further include selecting 506 at least one metamorphic and/or feature of a feature game to upgrade with at least one random upgrade chance associated with the multi-trigger symbol.

In the exemplary embodiment, process 500 may further include, for each selected metamorphic feature, causing 508 the display of the gaming device to show application of at least one random upgrade chance associated with the multi-trigger symbol to the selected metamorphic and/or feature(s). As described above, audible and/or visual changes may accompany at least steps 506 and 508 in connection with such application of at least one random upgrade chance. These audible and visual changes may include sound effects, overlays and/or changes to a background of the game display (e.g., changing images, changing colors, highlighting/graying-out portions of the display), each of which may be associated with a particular feature or application of a random upgrade chance of the multi-trigger symbol. In cases where multiple features are activated, multiple audible/visual changes may be implemented. Once activated, the feature may remain activated for a certain, predefined period (e.g., a number of turns or number of free spins, an amount of time, and/or until a game session is ended). The audible/visual change and game mechanic associated with the feature may remain present during this period.

FIGS. 6A-6L depict an example game interface 600, which may be displayed for example by gaming devices 104A-104X and/or mobile gaming devices 256 while performing process 400 and/or process 500. In the exemplary embodiment, game interface 600 includes a set of reels 602 in which a game outcome including a plurality of symbols may be displayed, and at least one metamorphic 604 associated with metamorphic features. Metamorphic 604 may include a “Bonus” meter, which provides a visual and/or audible representation to a user of the game of the status of triggering a feature game during playing of the base game. In the example embodiment shown in FIG. 6A, game interface 600 includes a single metamorphic 604 corresponding to meter (e.g., 604) and being located above reels 602. The game outcome may be determined randomly, for example, by performing a lookup using one or more pay tables based on one or more RNG outcomes. The reels may be referred to as first through fifth reels, with the first reel being the left-most reel and the fifth reel being the right-most reel.

FIG. 6B depicts one or more multi-triggering symbols 606 (also referred to as multi-trigger symbols 606) that may be displayed as part of a game outcome on reels 602. Each multi-triggering symbol 606 is associated with metamorphic 604, and may have, for example, individual metamorphic features 608 (e.g., random upgrade/enhancement chances) that relate to triggering the metamorphic 604 from the base game and/or modifying prize meters of the feature game once gaining access to the feature game (described in detail below). In the example embodiment of FIG. 6B, metamorphic features 608 include miniature graphics within a multi-triggering symbol 606. The number of metamorphic features 608 is equal to the number of chances available to either upgrade metamorphic 604 to a sufficient level to activate the feature game and/or upgrade prize meters (described below) of the feature game that become available once the feature game is activated. For example, upgrading and/or enhancing may include upgrading/enhancing the metamorphic 604 to a “full” state to trigger the feature game, and/or upgrading/enhancing prize meters in the feature game to higher prize levels.

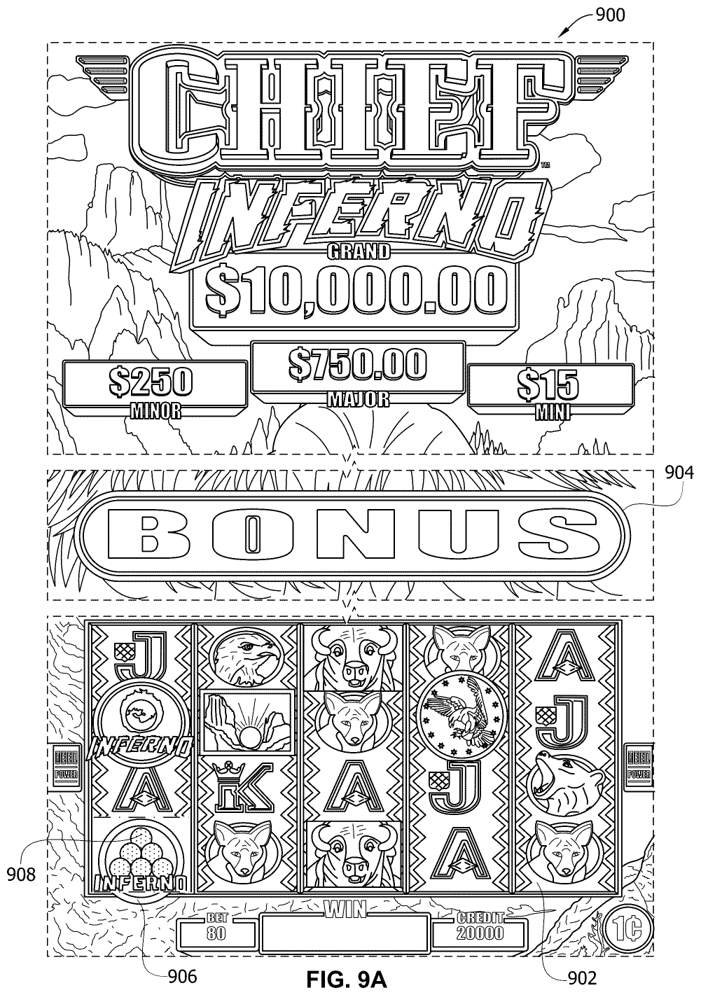

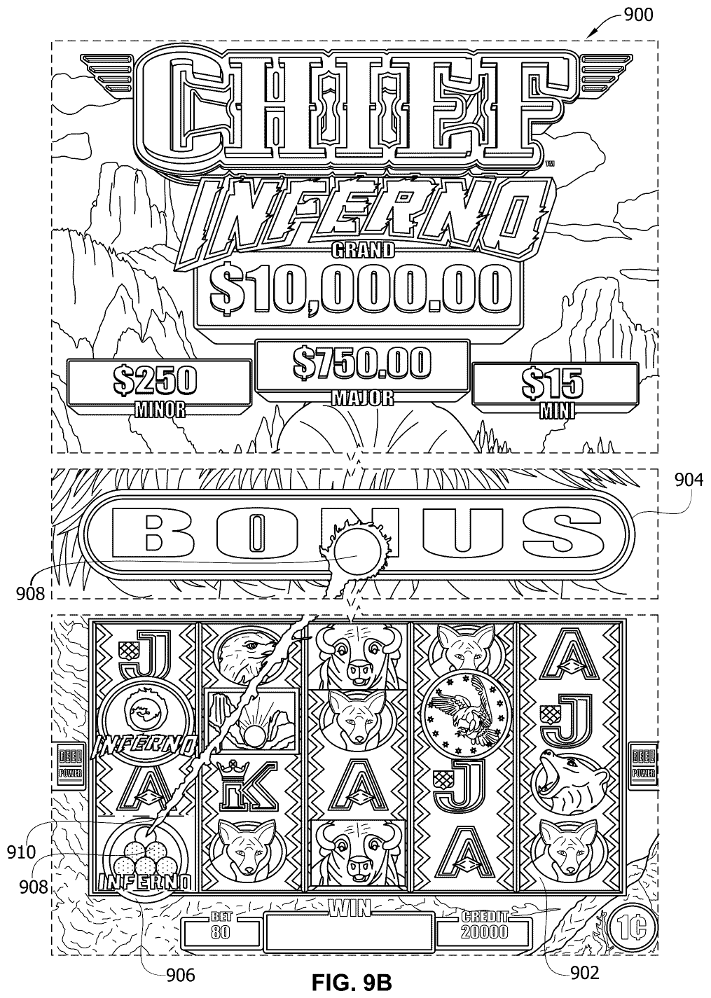

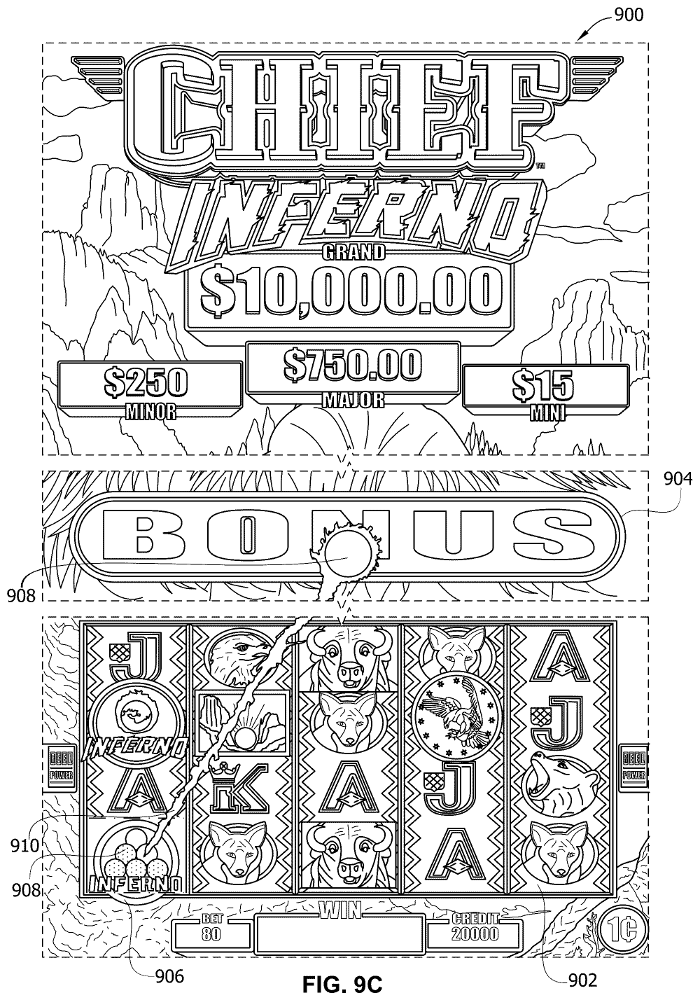

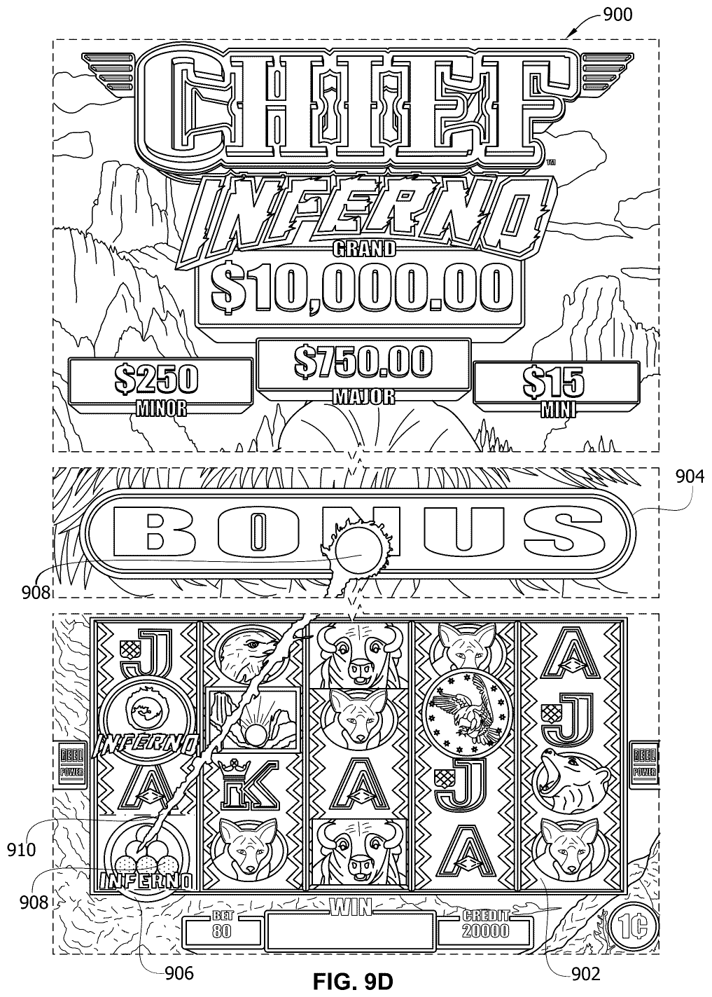

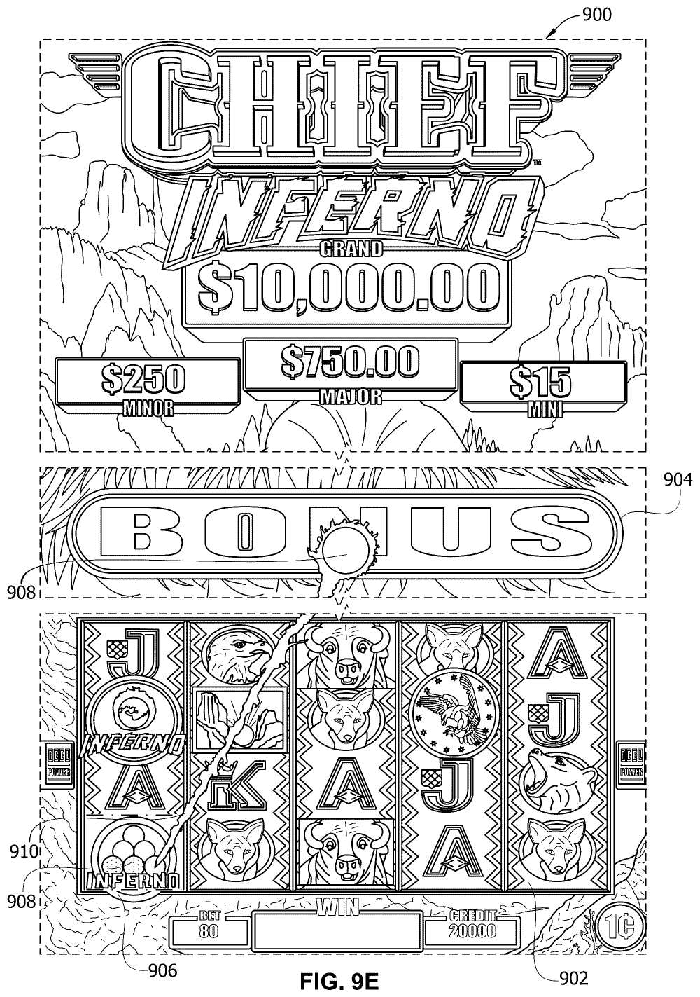

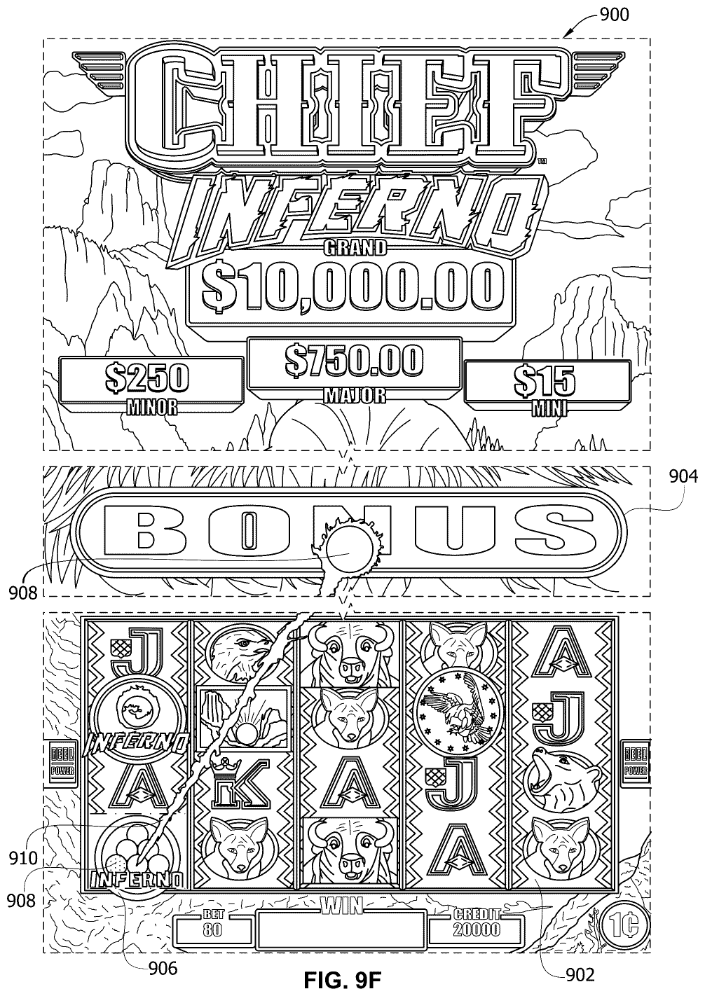

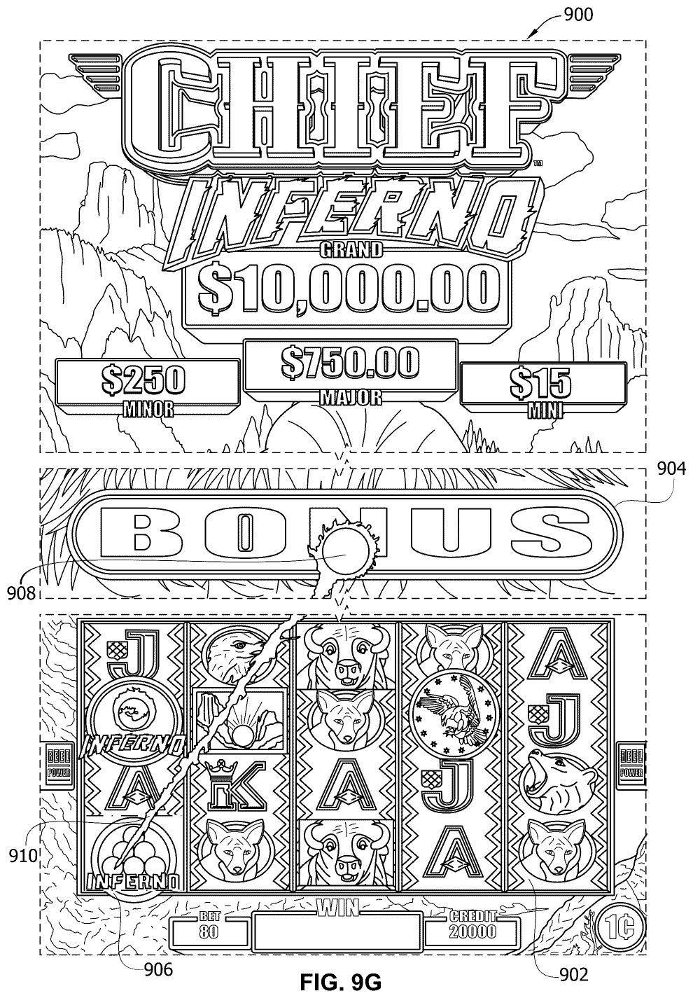

In the example embodiment of FIG. 6B, metamorphic features 608 are depicted as miniature fireball graphics within the center of multi-triggering symbol 606. There may any number of different types of multi-triggering symbol 606 with respect to how many metamorphic features 608 are provided by each type of multi-triggering symbol 606. In one embodiment, there may be three different types of multi-triggering symbol 608, each having a different number of metamorphic features 608 corresponding to a different number of upgrade/enhance chances. As shown in FIG. 6B, a first type of multi-triggering symbol 606 has one metamorphic feature 608 (e.g., one (1×) miniature fireball graphic) that corresponds, for example, to one chance to upgrade metamorphic 604 in the base game to trigger the feature game. There is also a second type of multi-triggering symbol 606 that has six (6×) metamorphic features 608 (e.g., six miniature fireball graphics), corresponding to six chances to upgrade either metamorphic 604 (in the base game) or prize meters (in the feature game) (shown, for example, in FIGS. 9A-9G).

FIG. 6C depicts a third type of multi-triggering symbol 606 that has eight metamorphic features 608 (e.g., eight (8×) miniature fireball graphics), corresponding to eight chances to upgrade either (i) metamorphic 604 (in the base game) or (ii) prize meters (in the feature game).

In the exemplary embodiment, an RNG call may be performed to determine whether to display the first type (e.g., one fireball graphic) and/or second type (e.g., six fireball graphics) of multi-triggering symbol 606 regardless of an amount of credits played, whereas the third type (e.g., eight fireball graphics) may only be displayed if a certain threshold amount of credits are played, such as an elevated or maximum credit play. When a multi-triggering symbol 606 is displayed, an RNG call may be performed to determine whether to upgrade metamorphic 604 in the base game and/or upgrade prize meters in the feature game, depending on the number of metamorphic features 608 present in multi-triggering symbol 606. In a preferred embodiment, the maximum metamorphic features 608 that any one multi-triggering symbol 606 can have is eight metamorphic features 608 (corresponding, for example, to eight fireball graphics as shown in FIG. 6C, which equates to eight chances to upgrade metamorphic 604 in the base game and/or upgrade prize meters in the feature game using any remaining chances 608 after triggering the feature game). As such, any one multi-triggering symbol 606 may trigger up to eight different RNG calls to determine whether to use each of eight potential metamorphic features 608 to upgrade metamorphic 604 in the base game and/or upgrade prize meters in the feature game (and likewise six different RNG calls for the second type of multi-triggering symbol 606 and one RNG call for the first type of multi-triggering symbol 606).

The 8× fireball version of multi-triggering symbol 606 may be configured such that each fireball of the eight fireballs increases the chance to trigger either the feature game or an increased prize in the feature game more than the prior fireball(s). In other words, the later fireballs in the 8× configuration may be weighted to have a higher chance than the earlier fireballs to trigger the feature game. In one aspect, this means that the eighth fireball may have the highest chance to trigger either the feature game or an increased prize in the feature game. In another aspect, this means that the sixth or seventh fireballs may have the highest chance(s) to trigger the feature game, whereas the eighth fireball would be used to upgrade one of the meters of the feature game (e.g., trigger an increased prize in the feature game). These are just two examples of how weighting can be set. Because the number of fireballs that remain influence what the upgrades will be, weights can be shifted such that depending on how many chances remain, certain fireballs (such as the second or third to last fireballs of the 8× fireball version of metamorphic trigger symbol 606) have a more likely chance to trigger the feature game than other fireballs (such as the very last (e.g., eighth) fireball). Thus, after weights of the multi-triggering symbol 606 have been determined, the weight cans be shifted to create different outcomes. The weights may be determined/shifted by reference to one or more lookup tables (e.g., weighted tables) as part of a technical solution that satisfies regulatory requirements for randomness and RTP, as described herein. For example, the weights may be shifted by referencing a lookup table relating to parameters of the feature game and that uses random numbers generated by one or more RNGs, so as to achieve a given level of volatility for a target level of RTP, where an RNG of a first threshold amount may trigger an increase in weights, and an RNG of a second (different) threshold amount may not trigger an increase in weights. Additionally, a total amount of multi-triggering symbols 606 and a maximum of any one type of multi-triggering symbol 606 may be defined. For example, there may be limits on the combinations of multi-triggering symbols 606 permitted during gameplay, where a maximum of four multi-triggering symbol 606 is permitted across the reels, and only two of the four may be of the 6× or 8× variety, whereas the remaining two multi-triggering symbol 606 may be of the 1× type. As such, one potential maximum number of random chances from multi-triggering symbols 606 in a given spin of the reels is 19 random chances (resulting from the presence of two 8× fireballs and two 1× fireballs). This distribution can be implemented via respective RNG calls associated with distributing a permissible amount and type of multi-trigger symbols 606.

FIG. 6D depicts visual graphic 610 associated with triggering of metamorphic 604 via metamorphic features 608 of a multi-triggering symbol 606. This visual graphic 610 may include a visual (and audible) effect associated with the distribution of metamorphic features 608 from multi-trigger symbol 606 to metamorphic 604. In the example embodiment shown in FIG. 6D, this visual graphic 610 includes flare/fire graphics that trail behind any fireball shot up from amongst the 1×, 6×, and/or 8× type of multi-triggering symbol 606 to trigger metamorphic 604 (e.g., to trigger the Bonus meter). Visual graphic 610 may correlate 1:1 with metamorphic features 608, in that each time a metamorphic feature 608 is used to upgrade metamorphic 604, a corresponding visual graphic 610 appears. Visual graphic 610 may include flare/fire graphics that may shoot up immediately when the reel containing the multi-trigger symbol 606 lands. Metamorphic 604 may be programmed to require a certain number of upgrades from the fireballs of multi-triggering symbol 606 in order to fully activate (or “fill”) metamorphic 604 to enter into the feature game.

Each “hit” on metamorphic 604 from a fireball triggers an incremental increase in a fill state of metamorphic 604. Metamorphic 604 increases (up to its maximum fill state) with each fireball shot up to metamorphic 604. When metamorphic 604 reaches its maximum fill state, a triggering phase begins as the feature game is entered. Reference character 608 may be used herein to designate both fireballs present within the body of multi-trigger symbol 606 as well as fireballs shot from multi-trigger symbol 606.

FIG. 6D also depicts visual changes in metamorphic 604 when it is hit with a launched fireball from multi-triggering symbol 606. As shown in the example embodiment of FIG. 6D, when metamorphic 604 is “hit,” it may change in appearance (as compared to metamorphic 604 as depicted in FIG. 6C) to illustrate to the user that the corresponding metamorphic feature has been “hit” and/or activated. This may include metamorphic 604 being substantially surrounded by and/or engulfed in a graphic, such as flame graphics (described in more detail below).

FIGS. 6E-6G depict an example visual change of metamorphic 604 when the game is transitioning from the base game to the feature game (e.g., a trigger phase). For example, once metamorphic 604 has received enough upgrades from metamorphic features 608 of multi-triggering symbol 606 to enter the feature game, visual graphics associated with metamorphic 604 appear to indicate to the user that the feature game is starting.

More specifically, FIG. 6E depicts early trigger phase transition graphics 612 of metamorphic 604 as the base game begins its transition to the feature game. FIG. 6F depicts intermediate trigger phase transition graphics 614 of metamorphic 604 as the transition from the base game to the feature game continues. FIG. 6G depicts late trigger phase transition graphics 616 of metamorphic 604 as the base game reaches its final transition state to the feature game. As shown in FIGS. 6E-6G, the change in appearance in visual graphics 612, 614, and 616 generally includes an increasing number of graphics that gradually encompass metamorphic 604 until metamorphic 604 in its original form as shown in the base game (e.g., FIG. 6C) is no longer visible due to being overlaid by late trigger phase transition graphics 616.

Visual graphics 612, 614, and 616 may collectively be referred to as pre-feature game graphics, as they are present at the beginning of the trigger phase (e.g., the transition from the base game to the feature game). In the example embodiments of FIGS. 6E-6G, early trigger phase transition graphics 612 may include flame graphics located at the base of metamorphic 604. Intermediate trigger phase transition graphics 614 may include flame graphics that gradually engulf metamorphic 604, starting for example from the left end of metamorphic 604 and continuing to the right end of metamorphic 604, with the metamorphic 604 gradually disappearing from left-to-right as the flame graphics progress. This intermediate trigger phase transition state may also include additional visual graphics such as beams of heat/flames emanating from certain points of the body of metamorphic 604.

Additionally, if metamorphic 604 is configured to display a word such as “BONUS,” the additional visual graphics may emanate from in between and/or around the permitters of the letters of the word “BONUS.” Late trigger phase transition graphics 616 of metamorphic 604 may include flame graphics that completely engulf metamorphic 604 such that metamorphic 604 in its original form as shown in the base game (e.g., FIG. 6C) is no longer visible.

FIGS. 6H-6J depict an example of a transition of metamorphic 604 from a single meter (e.g., 604) in the base game to a plurality of prize meters 618, 620, 622, and 624 in the feature game, along with accompanying late trigger phase graphics 628, 630, and 632. Feature game graphics 628, 630, and 632 may also be referred to as post-feature game graphics as they are present as the trigger phase is ending and the feature game is beginning (e.g., as the prize meters of the feature game begin to appear). In the exemplary embodiment, prize meters 618, 620, 622, and 624 are prize meters for prizes potentially available to win in the feature game.

In the example embodiments depicted in FIGS. 6H-6J, prize meter 618 may be a free games (e.g., free spins) prize meter. Prize meter 620 may be a feature symbol prize meter that relates to awarding a certain amount of symbols that reflect a main element of the game (e.g., a main character or main theme of the game). Prize meter 622 may be a wild symbol prize meter that awards “wild cards” that can be used to modify other landed symbols to award wins. Prize meter 624 may be a jackpot prize meter that awards various jackpots based upon certain criteria. The continued transition from metamorphic 604 in the base game to prize meters 618, 620, 622, and 624 in the feature game as shown in FIGS. 6H-6J immediately follows the transition depicted in FIGS. 6E-6G when metamorphic 604 received enough upgrades from metamorphic features 608 to enter the feature game.

With reference to FIG. 6G, late trigger phase transition graphics 616 may be programmed to visually dissipate once the feature game starts, revealing prize meters 618, 620, 622, and 624 in place of prior metamorphic 604. In the example where late trigger phase transition graphics 616 are flame graphics, once the flame graphics visually dissipate, prize meters 618, 620, 622, and 624 start to gradually become visible on the game display. Feature game graphics 628, 630, and 632 may include graphics similar to graphics 612, 614, and 616, but instead of gradually engulfing metamorphic 604 as graphics 612, 614, and 616 do, feature game graphics 628, 630, and 632 gradually disappear to reveal prize meters 618, 620, 622, and 624. In the exemplary embodiment, feature game graphics 628 are early feature game graphics and may include flame graphics that may shroud prize meters 618, 620, 622, and 624 in a partially transparent manner. Feature game graphics 630 are intermediate feature game graphics and may include flame graphics that may have a greater degree of transparency than graphics 628, and as such show more of prize meters 618, 620, 622, and 624. Feature game graphics 632 are late feature game graphics and may include flame graphics that have receded down to a base portion of prize meters 618, 620, 622, and 624 such that prize meters 618, 620, 622, and 624 are essentially fully visible. When base game play is resumed, metamorphic 604 appears again to replace prize meters 618, 620, 622, and 624.

FIG. 6K depicts the manner in which metamorphic features 608 of multi-triggering symbol 606 are distributed to upgrade prize meters 618, 620, 622, and 624 once the feature game is triggered, but before any feature game reel spins (e.g., free games/free spins) begin. If, after the feature game is triggered, there are remaining metamorphic features 608 on any given in-game multi-triggering symbol 606, the remaining metamorphic features 608 will be distributed to one or more of the prize meters 618, 620, 622, and 624 based on the RTP and/or RNG settings as described herein. Similar to what is shown in FIG. 6D, metamorphic features 608 are launched from multi-triggering symbol 606 and upgrade at least one of prize meters 618, 620, 622, and 624.

Each use of a metamorphic feature 608 reduces the total amount of metamorphic features 608 left to use. Each subsequent use of a metamorphic feature 608 on a prize meter 618, 620, 622, and/or 624 will level up the respective prize meter 618, 620, 622, and/or 624 to increase the prize level of that particular prize meter. For example, FIG. 6K depicts metamorphic feature 608 upgrading prize meter 624. The first time that prize meter 624 is upgraded by a metamorphic feature 608, it triggers a first prize state that is able to be won once the feature game begins. In the case of prize meter 624 which relates to jackpot prizes, the first prize that becomes available to win is a “MINI” jackpot, unlocked by the first fireball hit. Any next upgrade of prize meter 624 by a subsequent metamorphic feature 608 enhances the prize level to the next level. In the exemplary embodiment, the order of levels of unlocked prizes for prize meter 624 goes from level 1: “MINI,” to level 2: “MINOR,” to level 3: “MAJOR,” to level 4: “GRAND.” For example, the jackpot levels shown in FIG. 6K may be highlighted (e.g., via visual graphics) to show the user which jackpot is currently activated on prize meter 624 (e.g., when prize meter 624 has reached the level 2: “MINOR” jackpot, the word “MINOR” may be visually and/or audibly highlighted/emphasized on the display/cabinet speakers to indicate to the user that the “MINOR” jackpot level has been reached (likewise for when the other jackpot levels are reached)). To achieve this, each RNG call determines which prize meter 618, 620, 622, and/or 624 to upgrade using a different pay table or series of lookup values associated with the metamorphic feature and based on the remaining amount of metamorphic features 608 that are available to provide such upgrades.

Moreover, metamorphic features 608 may be weighted differently according to weights provided in a corresponding pay table or lookup values/lookup tables as described herein. This means that for a multi-triggering symbol 606 that has eight metamorphic features 608, the eighth upgrade chance may have more weight than any prior upgrade chance (e.g., metamorphic features 1-7). However, this is just one example of weighting, and different metamorphic features 608 such as the next to last metamorphic feature 608 may be weighted to have the highest chance to trigger the feature game, as described herein. FIG. 6K also depicts an extra reels feature 626 that may allow a user to add extra reels to the base configuration of reels as described herein.

FIG. 6L depicts aspects of prize meters 618, 620, 622, and 624 being leveled up during the course of metamorphic features 608 being distributed to one or more of prize meters 618, 620, 622, and 624. In the exemplary embodiment, if there are remaining metamorphic features 608 available after the feature game has been triggered, the remaining metamorphic features 608 are randomly distributed to prize meters 618, 620, 622, and 624 to cause corresponding upgrades to the level of the respective prize meter, as shown in FIG. 6K. FIG. 6L depicts playing of the feature game and shows how each prize meter conveys the prizes that were triggered at the start of the feature game (e.g., resulting from the distribution of the remaining metamorphic features 608 to prize meters 618, 620, 622, and/or 624).

In an example embodiment shown in FIG. 6L, prize meter 618 includes visual information 634 regarding how many free games (e.g., free reel spins) were won and are available. Prize meter 620 includes visual information 636 regarding how many feature symbol prizes were triggered. Prize meter 622 displays visual information 638 regarding how many wild symbol prizes were triggered. Prize meter 624 displays visual information 640 regarding which level jackpot was triggered. During the feature game, the prizes associated with each prize meter may be awarded if an associated symbol 642 appears on a set of reels 602. In the example embodiment of FIG. 6L, symbol 642 is a coin graphic. To achieve this, each RNG call determines which set of reels 602 to place symbol 642 by using a certain pay table or series of lookup values associated with the feature game. As shown in FIG. 6K, various reels (e.g., 602) may continue spinning until all enhancements (provided via the metamorphic features 608) to the prize meters 618, 620, 622, and 624 have been implemented. Then, as shown in FIG. 6J, the reels 602 are determined based at least in part on the final enhancement (e.g., increased) state of the prize meters 618, 620, 622, and 624 as achieved from the distribution of the metamorphic features 608, and according to the RTP and RNG settings described herein. For example, one or more additional RNG calls and/or other determinations may be performed to determine the reels 602 shown in FIG. 6J.

Additional aspects of the multi-triggering symbol 606 are disclosed below. Multi-triggering symbol 606 may have its own visual graphics and/or metamorphic features. For example, upon the dispersal of each metamorphic feature 608, the position formerly occupied by the dispersed metamorphic feature 608 may change color or otherwise be visually modified to indicate to the user that that particular location no longer has an associated metamorphic feature 608. This is partially depicted in FIG. 6K, where after the first metamorphic feature 608 (e.g., miniature fireball graphic) launches, the location within multi-triggering symbol 606 that such first upgrade chance 608 launched from may turn gray or otherwise be devoid of a fireball. The game therefore provides a manner in which the user can easily keep track of how many metamorphic features 608 are left for any particular upgrade to metamorphic 604 and/or the meters of the feature game.

With reference to FIG. 6K, each subsequent metamorphic feature 608 that is dispersed will change the appearance of multi-triggering symbol 606 as the amount of available metamorphic features 608 decreases. Moreover, multi-triggering symbol 606 can have other graphics of its own. For example, multi-triggering symbol 606 may have flame graphics surrounding its outer periphery as shown in FIGS. 6B-6K, and the flame graphics may have associated movement to provide a visual cue and/or visual appeal. Such periphery flame graphics of multi-triggering symbol 606 may, for example, be configured to swirl in a counter-clockwise motion about the graphics located in the middle of multi-triggering symbol 606. The graphics in the middle of multi-triggering symbol 606 may also be animated for similar reasons.

Additional aspects of graphics 610 and additional associated graphics are disclosed below. Each location from which an individual fireball (e.g., 608) within multi-trigger symbol 606 was shot may change appearance upon launch of the fireball. For example, after a fireball is shot up to metamorphic 604, FIG. 6K depicts a grayed-out spot from which the fireball launched. This provides a visual cue to the user of a usage state of the fireballs (e.g., launched and available fireballs). Graphics 610 of any 1×-type multi-trigger symbol 606 may display quick enough to not cause any extended reel spin(s). Multi-fireball multi-trigger symbols 606 (e.g., 6×- and/or 8×-type(s)) may extend remaining reel spins while they shoot up to a prize meter, at approximately ⅓ second per shooting flare graphic. When a fireball triggers metamorphic 604, all remaining spinning reels may be held spinning while metamorphic 604 fills up and animates along with other gameplay aspects, such as audio aspects including a feature bell ringing. If a multi-fireball symbol triggered the feature with fireballs remaining, the symbol may keep those ‘unshot’ fireballs “lit.” Each remaining spinning reel after a feature trigger may have corresponding audio/visual sensory mechanisms, such as an animation in the form of an anticipation effect (e.g., ember graphics appear over the reel) and/or sound effects such as hooves hitting the ground sound effect).

If an anticipated reel lands a multi-triggering symbol 606, it may land with a certain animation and sound (such as a “hit” animation and sound) but will not shoot fireballs up until the trigger phase that takes place after the spin is finished. When all reels have landed after a feature triggering spin, all supplemental reel wins (e.g., Xtra Reel Power wins via extra reels feature 626) may be shown first, if applicable. Then the trigger phase begins. As discussed, each multi-triggering symbol 606 can include single (1×) and multi-(6×, 8×) fireball symbols. Each 1× fireball has one random chance to trigger the feature game, each 6× fireball has six random chances to trigger the feature game, and each 8× fireball has eight random chances to trigger the feature game. In the feature game trigger phase, all symbols and reels may dim except for those multi-triggering symbols 606 that have at least one fireball remaining lit. Multi-triggering symbols 606 may also include animations, such as swirling fire graphics. If there are no unlit fireball symbols remaining, it may be the case that no swirling fire graphics appear and no additional fireballs are shot. As discussed, any remaining fireballs from any multi-triggering symbols 606 present during the base game and the transition to the feature game may then be applied to the prize meters 618, 620, 622, and 624 in the feature game. The distribution of fireballs (e.g., 608) to prize meters 618, 620, 622, and 624 may include accompanying graphics/animation of fireballs shooting to prize meters similar to comparable fireball graphics described herein. These “fireballs shooting to prize meters” animations may take around one second per fireball and may include an additional animation that “shakes” the prize meter hit by the fireball. When a fireball symbol is spent, the swirling fire may be removed from that symbol. When the feature game trigger phase is complete, free games may then start with the indicated upgrades (e.g., enhancements) resulting from any upgrade/enhancement of the prize meters from the fireball hit upgrades/enhancements.

Additional aspects and/or embodiments of prize meters 618, 620, 622, and 624 are disclosed below. Prize meters 618, 620, 622, and 624 may appear after the base game spin that triggers the feature game. The feature game may include a free games (e.g., free spins) feature, where the amount of available free games/free spins is based on a game outcome from the upgrade of the prize meters 618, 620, 622, and 624 via metamorphic features 608. Prize meters 618, 620, 622, and 624 may remain present throughout the free games feature of the feature game. When base game play is resumed, metamorphic 604 (e.g., Bonus meter) appears again to replace prize meters 618, 620, 622, and 624. While four prize meters 618, 620, 622, and 624 are described as being used in the feature game, more (or less) than four prize meters may be used. For example, additional prize meters may include alternate jackpots (e.g., other than those shown in connection with information 640) that may be available.

Additional aspects and/or embodiments of prize meter 618 and the free games feature are disclosed below. Prize meter 618 reflects the free games prize. An initial or standard number of free games appearing in prize meter 618 may be 8, as shown in FIG. 6K. For example, this initial 8 free games amount may be the minimum number of free games guaranteed due to entering the feature game. The number of free games may increase as a result of upgrades from metamorphic features 608 applied to prize meter 618 before the free games are played. During the trigger phase, prize meter 618 may include a phrase such as “Free Games Added,” whereas during the free games play, prize meter 618 may include a phrase such as “FREE GAME X of Y” (e.g., see 634 in FIG. 6L (“FREE GAMES 1 of 8”)), keeping the user apprised of remaining free games. Free Games added values may be +2, +3 and +5. When a fireball (e.g., 608) hits prize meter 618 (e.g., the Free Games meter), a graphic burst effect may appear on the meter showing the number of free games added. Prize meter 618 may have no maximum value. Metamorphic symbols may not appear in free games.

Additional aspects and/or embodiments of prize meter 620 and the feature symbol prize are disclosed below. Prize meter 620 reflects the feature symbol prize. Prize meter 620 may begin at a “blank” (zero) award state (no feature symbols have been awarded). Prize meter 620 may award feature symbols in sets of +20, +25, and/or +50. When a fireball (e.g., 608) hits prize meter 620, a graphic burst effect may appear on prize meter 620 showing the number of feature symbols awarded. For example, FIG. 6L depicts 50 feature symbols being awarded (see 636 in FIG. 6L). A maximum amount of awarded feature symbols may be 250, and there may be nine fixed prizes that add up to that amount—e.g., five 20's, two 25's, and two 50's.

Additional aspects and/or embodiments of prize meter 622 and the wild symbol prize are disclosed below. Prize meter 622 reflects the wild symbol prize. Prize meter 622 may begin at a “blank” (zero) award state (no wild symbols have been awarded). Prize meter 622 may award wild symbols using a static amount, such as +10 (see 638 in FIG. 6L). When a fireball (e.g., 608) hits prize meter 622, a graphic burst effect may appear on the prize meter showing the +10 wild symbols added. A maximum amount of awarded wild symbols may be 50.

Additional aspects and/or embodiments of prize meter 624 and the jackpot prize are disclosed below. Prize meter 624 reflects the jackpots prize. Jackpots may be unlocked at various levels, such as: Level 1: MINI; Level 2: MINOR; Level 3: MAJOR; Level 4: GRAND. Each fireball (e.g., 608) that hits prize meter 624 will advance it to the next level. When a fireball hits prize meter 624, a graphic burst effect may appear on the meter while it changes to the new list. Upon reaching level 4, the system may be programmed to not send anymore fireballs to prize meter 624. Prize meter 624 may be incapable of being increased during the playing of the free games feature of the feature game (e.g., it may only be able to be increased during the triggering spin). Prize meter 624 may show all possible jackpots during the trigger phase (with grayed-out locked jackpots as shown in FIG. 6K) but may only show the unlocked jackpots (see 640 in FIG. 6L) during the free games session(s).

Additional aspects of the symbol 642 in the free games feature are disclosed below. The system may be configured to include associate prize coins with each of the categories of the prize meters, include a coin (e.g., 642) for awarding free games, a coin (e.g., 642) for awarding feature symbols, a coin (e.g., 642) for awarding wild symbols, and a coin (e.g., 642) for awarding each of the jackpots, and these may appear on all reels. A coin (e.g., 642) for the mini jackpot may appear on the first reel. A coin (e.g., 642) for the minor, major, and grand jackpots, if unlocked, may appear on the first reel only. There may also be a coin (e.g., 642) that appears that is not associated with the prizes of the prize meters. Coin totals of 2, 3, 4 or 5 of any type landing scattered in any position may retrigger 5, 8, 15, or 20 free games, respectively. A retrigger banner may be displayed before awarding coin prizes. Coin symbols (e.g., 642) with prizes will award those prizes if they are part of a retrigger win. Jackpot coins may shoot flare graphics up to their corresponding jackpot prize amounts (the prize meter with the jackpot values themselves) and award the appropriate prize. In the free games feature, the unlocked jackpots are eligible in a lookup table to populate dynamic symbols in the free games. The game engine may look at the unlocked conditions when populating dynamical jackpot coins in the free games feature. Other coin prizes may shoot flare graphics up to their associated prize meters. Retriggers containing only regular coin symbols 642 may add more spins to the spin counter but may not shoot any flare graphics (see 642 in FIG. 6L). Coins associated with the prize meters may be referred to as supercoins.

FIGS. 7A-7G depict an example game interface 700 that is part of the feature game, which may be displayed for example by gaming devices 104 and/or mobile gaming devices 256 while performing process 400 and/or process 500. In the exemplary embodiment, game interface 700 includes a set of reels 702 (and symbols) and prize meters 704, 706, 708, and 710, which may function similarly to the reels 602 (and symbols) and prize meters 618, 620, 622, and 624 shown in FIGS. 6-6L, respectively. In an example embodiment, game interface 700 is the game interface displayed during free games as part of the feature game. Prize meters 618, 620, 622, and 624 remain present remain throughout the feature game.

More specifically, FIGS. 7A-7G depict an additional gameplay and metamorphic feature of the feature game based on if stacks of certain symbols appear. In a 4×5 reel matrix embodiment of the game (such as shown in FIGS. 6A-6L and 7A-7G), a stack of symbols may be defined as 4-high stack of a particular symbol from amongst the plurality of available symbols. The particular symbol may be a symbol representation of a main aspect of the game, such as a main character or other main theme or item relating to the underlying lore of the game, referred to herein as a “feature symbol.” FIG. 7A depicts game interface 700 having reels 702, prize meters 704, 706, 708, and 710 (similar to prize meters 618, 620, 622, and 624 in FIGS. 6H-6L), and a full feature symbol stack 712. When a stack occurs, the stack may transform into a related symbol defined as a tall symbol, as depicted by animation 714 in FIG. 7B. The tall symbol may use the same base image and/or graphics of the feature symbol, but have a larger size, such as to accommodate the space on an entire individual reel (e.g., 4-high, 1-across), or multiple reels (e.g., 4-high, 2-across, and so on and so forth up to the maximum number of reels and symbols spaces) (see tall symbol 716 in FIG. 7C). Thus, the initial image/graphic of a single feature symbol may be scaled in size to accommodate larger spaces relative to the spaces available in the reel matrix, as depicted in the various sizes of tall feature symbol 716 in FIGS. 7A-7G. For example, in a 4×5 embodiment, the largest amount of space a tall symbol can occupy is the entire 4×5 reel matrix (e.g., 4-high, 5-across, as depicted in FIG. 7G). Such stacks may appear on some or all reels, may have a random multiplier 718 assigned thereto (e.g., by virtue of a corresponding RNG call as described herein), and the stacks may merge together to combine multipliers as shown in FIGS. 7C-7G. The multiplier amounts may therefore depend on how many stacks merged, and/or other factors (e.g., multiplier limit rules that are provided in a corresponding look-up table). For example, a first (e.g., 5×) multiplier as shown in FIG. 7C may appear within the display area of the corresponding reel(s) via an animated horizontal movement direction (e.g., from left to right), and each subsequent multiplier 718 (e.g., ×53 shown in FIG. 7D, ×100 shown in FIG. 7E, ×280 shown in FIG. 7F, and ×392 shown in FIG. 7G) may be displayed using the same horizontal flow (e.g., scroll) visual. During the calculation of each multiplier 718, intervening multipliers may be shown (e.g., scrolled) within the corresponding reel(s) display area, such as ×5 and ×20 (sub-) multipliers that results in an overall ×100 multiplier (e.g., the left-to-right scrolling would show ×5 . . . ×20 . . . ×100 . . . , and so on and so forth). The animation 714 associated with each landed full stack 712 may be overlaid by the graphic of the corresponding multiplier 718, such that each multiplier 718 scrolls across the animation spanning across the one or more full stacks 712. For example, taking FIGS. 7A-7D as an example subset of reel behavior from amongst FIGS. 7A-7G, the leftmost full stack 712 shown in FIG. 7A changes via animation 714 shown in FIG. 7B to a tall symbol 716 shown in FIG. 7C that occupies the space of the leftmost reel 702. Meanwhile, as shown in FIGS. 7B-7D, the reel 702 directly adjacent the leftmost reel 702 also lands a full stack 712 shown in FIG. 7B and transitions via animation 714 shown in FIG. 7C to a tall symbol 716 shown in FIG. 7D, where the tall symbol 716 shown in FIG. 7D occupies the space of the two leftmost reels 702. The various multipliers 718 may be configured to scroll horizontally across animation 714 during transition from a single-wide (e.g., one reel column) tall symbol to a double-wide (e.g., two reel columns) tall symbol, for example, and potentially so on and so forth depending on the game outcome, until a final tall symbol is determined (such as the five-wide (e.g., five reel columns) tall symbol 716 shown in FIG. 7E). Animation 714 may alternatively be a static graphic, or a combination of an animation and a static graphic (e.g., animation 714 may at first be a moving animation indicating transition from a full stack 712 to a tall symbol 716 and then settle on a static background graphic once the transformation is complete, and multipliers 718 may overlay either or both of the animation and/or static graphic). In another example of multipliers 718, the ×5 multiplier shown in FIG. 7C may instead by an ×6 multiplier, the ×53 multiplier shown in FIG. 7D may instead be an ×42 multiplier, and the ×100 multiplier shown in FIG. 7E may instead be an ×252 multiplier (where the transformation from a single-wide symbol 716 to a triple-wide symbol 716 is accompanied by the overlaid horizontally scrolling graphics representing the ×6, ×42, and ×252 multipliers (e.g., where ×6 times ×42=×252). By way of displaying multipliers 718 in such a left-to-right horizontal scrolling manner, anticipation may build in the user (since the user can also calculate the final amount of the multiplier based on the (sub-) multiplier values that scroll left-to-right across the reel(s) display area). Other scrolling directions (e.g., bottom to top) may be utilized to portray the various multipliers 718 within the corresponding reel display area and to convey the multipliers 718 to the user. These are just a few examples of multiplier levels and the manner of display of such multipliers to a user. The ×5, ×53, ×100, ×280, and ×392 multipliers 718 shown in FIGS. 7C-7G, and the other multiplier multiples described herein are not limiting. A tall symbol that occupies a single reel may act as a single symbol on that reel for certain win calculations, such as for modified reel configurations (e.g., for “Xtra Reel Power” win calculations in an “Xtra Reel Power” reel configuration, such as when extra reels feature 626 in FIG. 6K is activated by a user). Any or all feature symbol wins that include a tall symbol may be multiplied by the corresponding multiplier displayed. Any or all adjacent reels with a tall symbol may merge upon landing to show a single combined multiplier. Non-adjacent tall symbols may not merge, but still have their respective multipliers combined when calculating wins.

In the exemplary embodiment, and as shown in FIG. 7A, a full stack 712 of feature symbols may be displayed as part of a game outcome on reels 702 and trigger additional outcomes. A feature symbol is a symbol that appears on reels 702 that reflects a main character and/or main theme of the game and may display such using an image or other graphic as the feature symbol. As shown in FIG. 7B, full stack 712 from FIG. 7A is upgraded or converted to tall symbol 716 which replaces full stack 712 in its original reel 702 as another stack 712 results on an adjacent reel 702. The replacement of full stack 712 with tall symbol 716 may be displayed using animation 714. In an example embodiment, animation 714 may be similar in style to other animations and/or graphics used in other game modes and/or on other indicators, such as flame graphics. FIG. 7C depicts left-most reel 702 as containing tall symbol 716 as the next right-ward reel 702 has animation 714 as it is being converted or upgraded to a tall symbol. The adjacent tall symbols and subsequent full stacks 712 on adjacent reels 702 may collectively be converted or upgraded to a tall symbol 716, where a symbol of tall symbol 716 matches the feature symbol of full stacks 712 in an example embodiment. As the outcomes progress, tall symbol 716 replaces the most prior adjacent stack(s) 712 of the series of full stacks 712 that resulted in the awarding of tall symbol 716. An RNG call and/or other determination (e.g., based on the displayed game outcome) may be performed for each displayed full stack 712 to determine if there is an adjacent full stack 712 on a different set of reels 702, and that full stacks 712 are eligible to be converted or upgraded to a tall symbol 716. One or more additional RNG calls and/or other determinations may be performed to determine which tall symbol 716 to display (e.g., which size (width) of tall symbol 716). As shown in FIGS. 7D-7G, each successive tall symbol 716 replaces the preceding adjacent full stacks 712 that resulted in the awarding of tall symbol 716, such that tall symbol 716 increases in size until it encompasses all of the space normally occupied by reels 702 (if the outcome of the game was a plurality of adjacent full stacks 712 being awarded a tall symbol upgrade). FIG. 7D depicts tall symbol 716 that replaced full stacks 712 in each of the two left-most reels 702. FIG. 7E depicts tall symbol 716 that replaced full stacks 712 in each of the three left-most reels 702. FIG. 7F depicts tall symbol 716 that replaced full stacks 712 in each of the four left-most reels 702. FIG. 7G depicts tall symbol 716 that replaced full stacks 712 in all five reels 702. Additionally, as shown in FIGS. 7A-7G, the other reels 702 continue to spin as any one reel 702 including a full stack 712 is converted or upgraded to a tall symbol 716. Each tall symbol 716 may include and display its own multiplier 718 that serves as an enhancement during gameplay. Multiplier 718 is a graphic that conveys a multiplier enhancement (e.g., ×5 multiple, ×35 multiple, and higher) to the user resulting from achieving tall symbols during gameplay, and, for example, awards credits corresponding to the number of credits played as modified by the multiplier amount (e.g., ×5). Animation 714 may include a plurality of animations, for example for displaying the transition from a single full stack 712 to a single tall symbol 716, for displaying multiplier 718, and/or for displaying the merging of adjacent full stacks 712.

An example embodiment of an implementation of tall symbol gameplay mechanics is provided below. Game interface 700 (and likewise game interface 600) may include a five-reel interface, with each of a first reel, second reel, third reel, fourth reel, and fifth reel having four spots for symbols (e.g., a 4×5 reel configuration). When a full stack (e.g., 712) lands in a winning (or potential winning) combination, it will become a tall symbol (e.g., 716) which may also have a random multiplier (e.g., 718) associated therewith. The meaning of “potential win” is when a feature symbol stack (e.g., 712) lands on the first reel, or when another special symbol (such as a wild symbol that has a special function as a “wild card”) lands on the second reel without any feature symbol on the first reel.

The tall symbol gameplay mechanics may operate according to the example below. A first reel (e.g., 702) to have a tall symbol (e.g., 716) (regardless of what actual reel number it is) will draw from a first reel lookup table, such as a first reel multiplier table. An animation (e.g., 714, also referred to as a reveal animation) is played corresponding to the multiplier result.

A second reel to have a tall symbol (regardless of what actual reel number it is) will draw from a second reel lookup table, such as a second reel multiplier table. If the second reel is adjacent to the first reel tall symbol, the reels will merge together into a double-wide tall symbol (e.g., FIG. 7D) which may or may not include a multiplier. As part of animation 714, dynamically created text may animate with a right-to-left horizontal spin on the double-wide merged tall symbols. Values shown on the spin may be the product of the first determined multiplier times all possible values for the second reel multiplier. For example, the spinning values may be the first reel multiplier times each of 5×, 6×, 8×, and/or 10× multiples. If the first reel and second reel tall symbols are not adjacent, the second reel will use reveal animations for a single tall symbol.

A third reel to have a tall symbol (regardless of what actual reel number it is) will draw from a third reel lookup table, such as a third reel multiplier table. If it is adjacent to the second reel tall symbol, they will merge together into a double-wide (e.g., FIG. 7D) or triple-wide symbol (e.g., FIG. 7E) (depending on whether first and second merged) without a multiplier. An animation (e.g., 714) of dynamically created text will animate with a right-to-left horizontal spin on the wide merged tall symbols. Values shown on the spin will be the product of the previous merged multiplier times all possible values for the third reel multiplier. For example, the spinning values will be the former multiplier times each of 5×, 6×, 8×, and/or 10× multiples. If the second reel and third reel tall symbols are not adjacent, the third reel will use a reveal animation for a single tall symbol.

A fourth reel to have a tall symbol (regardless of what actual reel number it is) will draw from a fourth reel lookup table, such as a fourth reel multiplier table. If the fourth reel is adjacent to the third reel tall symbol, they will merge together into a double-wide (e.g., FIG. 7D), triple-wide (e.g., FIG. 7E), or quadruple-wide symbol (e.g., FIG. 7F) (depending on whether first/second/third merged) without a multiplier. An animation (e.g., 714) of dynamically created text will animate with a right-to-left horizontal spin on the wide merged tall symbols. Values shown on the spin will be the product of the previous merged multiplier times all possible values for the fourth reel multiplier. For example, the spinning values will be the former multiplier times each of 5×, 6×, and/or 8× multiples. If the third reel and fourth reel tall symbols are not adjacent, the fourth reel will use a reveal animation for a single tall symbol.

If a fifth tall symbol lands, before any merging takes place the current four-wide multiplier (e.g., FIG. 7F) may be rounded up to a threshold value. These thresholds may be located in a multiplier threshold lookup table. If the combined multiplier(s) from the four reels is/are less than a first threshold multiplier amount (e.g., less than 1200), then the new thresholded value will be that first threshold multiplier amount (e.g., 1200). If the previous combined multipliers amount to a number greater than the first threshold multiplier amount (e.g., 1200) and less than a second threshold multiplier amount (e.g., 1600), then the new thresholded value will be the second threshold multiplier amount (e.g., 1600). This same analysis and logic is repeated for each threshold level. The result is that there may be only five possible four-reel values after thresholding takes place. This thresholding may only be done if the fifth reel tall symbol lands. A fifth reel to have a tall symbol will draw from a fifth reel lookup table, such as a fifth reel multiplier table. In one embodiment, a tall symbol for the fifth reel scenario will always merge together into a quintuple-wide symbol (e.g., FIG. 7G). An animation (e.g., 714) of dynamically created text will animate with a right-to-left horizontal spin on the wide merged tall symbols. The values shown on the spin will be the product of the previous merged thresholded multiplier times all possible values for the fifth reel multiplier. For example, the spinning values will be the former multiplier times each of 4×, 5×, and/or 6× multiples.

Tall symbols can be utilized with other symbols as well, such as for special symbols (e.g., wild symbols that have a special function as a “wild card”). In an example embodiment, during the feature game (e.g., during free spins only), certain special symbols (e.g., wild symbols) that land in a win or a potential win may expand to fill their reel and turn into a tall symbol. If there is a tall feature symbol to the immediate left reel of a wild symbol, it may merge into the existing feature symbol stacks. If there is no tall feature symbol to its immediate left, a tall wild image may display. A tall wild symbol with a tall wild symbol to its immediate left may merge into a two-wide or three-wide wild tall symbol (similar to the two- and three-wide tall feature symbols FIGS. 7D and 7E). However, a tall feature symbol will never ‘merge into’ an existing tall Wild symbol. Tall wild symbols follow the same logic as tall feature symbol symbols regarding multipliers. Combinations of tall feature symbols and tall wild symbols use the appropriate multiplier tables from their combined count. This implementation of tall symbols provides added randomness to gameplay.

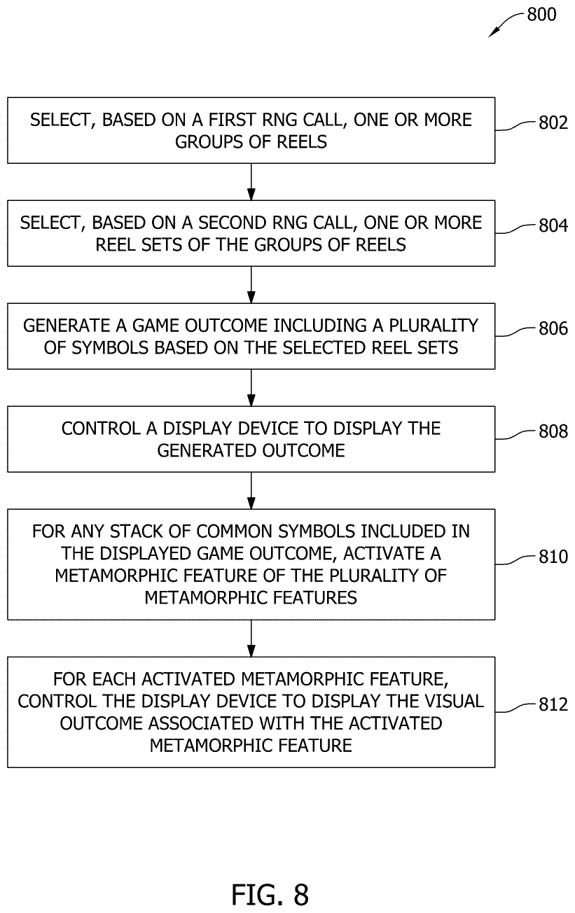

FIG. 8 is a flowchart illustrating an exemplary process 800 for electronic gaming using a tall symbol feature. Process 800 may be performed by system 100 (shown in FIG. 1), for example, using one or more server computers 102, gaming devices 104, and/or mobile gaming devices 256 (shown in FIG. 2), and in conjunction with aspects of process 400 (FIG. 4) and process 500 (FIG. 5).

In the exemplary embodiment, process 800 may include selecting 802, based on a first RNG call, a plurality of groups of reels that may be stored in a memory device (such as memory 208). Each group of reels may be able to display a plurality of different symbols that may be selected for display during a game outcome, for example, based on an RNG call and lookup table, as described above.

In the exemplary embodiment, process 800 may include selecting 804, based on a second RNG call, one or more reel sets from the plurality of selected reel groups. In some embodiments, different reel sets may be associated with different probabilities of displaying a certain symbol or stack of symbols. For example, within the first group, a first reel set may include a first number symbols and a second reel set of the first group of reel sets may include a second number of symbols. In this manner, a probability of each metamorphic feature being triggered may be controlled.

In the exemplary embodiment, process 800 may further include generating 806 a game outcome including a plurality of symbols based on the selected reel set and controlling 808 a display device (e.g., game displays 240 and 242) to display the generated game outcome.

In the exemplary embodiment, process 800 may further include controlling 808 the display device to display a visual outcome associated with the generated outcome. For example, as described above, the visual outcome may be a stack of common symbols, such as a stack of feature symbols and/or a stack of wild symbols.

In the exemplary embodiment, method 800 may further include, for any stack of common symbols, activating 810 a metamorphic feature associated with the stack of symbols. For example, as described above, a stack of symbols may have a predefined association with a metamorphic feature (e.g., a tall symbol metamorphic feature). As described above, the metamorphic features may include associated multipliers. In some embodiments, the metamorphic features may be triggered automatically. Additionally, or alternatively, other conditions, such as a certain RNG outcome and/or display of a certain symbol pattern, may need to be satisfied for the metamorphic feature to be activated. In situations in which is not practical or may cause confusion if multiple metamorphic features are performed at the same time, such as when the metamorphic features include bonus features and/or bonus games, the metamorphic features and/or their associated display outcomes may be performed sequentially.

In the exemplary embodiment, process 800 may further include, for each activated metamorphic feature, controlling 812 the display device to display a visual outcome associated with the activated metamorphic feature. In certain embodiments, the tall symbol metamorphic feature may be modified to span in part or in whole across applicable reel sets. For example, the tall symbol of the tall symbol metamorphic may be a larger version of the same symbol as symbols of the stack of common symbols.

FIGS. 9A-9G depict another example game interface 900, which may be displayed for example by gaming devices 104A-104X and/or mobile gaming devices 256 while performing process 400 and/or process 500, and has reels that are generally the same as or similar to those of game interface 600 (described above, for example), except for any differences described below. In the exemplary embodiment, game interface 900 includes a set of reels 902 (which is the same as or similar to reels 602, described above, for example) for the base game in which a game outcome including a plurality of symbols may be displayed, and at least one metamorphic 904 (which is the same as or similar to metamorphic 604, described above, for example) associated with metamorphic features (described below). FIGS. 9A-9G also depict one or more multi-triggering symbols 906 (which is/are the same as or similar to multi-triggering symbols 606, described above, for example) associated with metamorphic 904, and may have, for example, individual metamorphic features 908 (which is/are the same as or similar to metamorphic features 608, described above, for example) that relate to triggering the metamorphic 904 from the base game and/or modifying prize meters of the feature game once gaining access to the feature game (as described herein). In particular, FIGS. 9A-9G depict a firing sequence of a 6× embodiment of multi-triggering symbol 906 (e.g., six metamorphic features 908 represented as miniature graphics within multi-triggering symbol 906), where multi-triggering symbol 906 may also include a 1× or 8× embodiment (for example as described above in connection with the 1× (e.g., FIG. 6B) and 8× (e.g., FIG. 6C) embodiments of multi-triggering symbol 606).

FIG. 9A depicts a full 6× multi-triggering symbol 906 (e.g., none of the six metamorphic features 908 have been shot). Similar to FIG. 6D, FIGS. 9B-9G depict visual graphic 910 (which is the same as or similar to visual graphic 610, described above, for example) associated with triggering metamorphic 904 via metamorphic features 908 of multi-triggering symbol 906. FIG. 9B depicts a first metamorphic feature 908 being shot to metamorphic 904 as indicated by visual graphic 910, and five remaining (e.g., un-shot) metamorphic features 908 within the body of multi-triggering symbol 906 (where one metamorphic feature 908 is visually represented as having been shot (e.g., missing) from multi-triggering symbol 906 in connection with the shot metamorphic feature 908). FIG. 9C depicts a second metamorphic feature 908 being shot to metamorphic 904 as indicated by visual graphic 910, and four remaining (e.g., un-shot) metamorphic features 908 within the body of multi-triggering symbol 906 (where two metamorphic features 908 are visually represented as having been shot (e.g., missing) from multi-triggering symbol 906 in connection with the two shot metamorphic features 908). FIG. 9D depicts a third metamorphic feature 908 being shot to metamorphic 904 as indicated by visual graphic 910, and three remaining (e.g., un-shot) metamorphic features 908 within the body of multi-triggering symbol 906 (where three metamorphic features 908 are visually represented as having been shot (e.g., missing) from multi-triggering symbol 906 in connection with the three shot metamorphic features 908). FIG. 9E depicts a fourth metamorphic feature 908 being shot to metamorphic 904 as indicated by visual graphic 910, and two remaining (e.g., un-shot) metamorphic features 908 within the body of multi-triggering symbol 906 (where four metamorphic features 908 are visually represented as having been shot (e.g., missing) from multi-triggering symbol 906 in connection with the four shot metamorphic features 908). FIG. 9F depicts a fifth metamorphic feature 908 being shot to metamorphic 904 as indicated by visual graphic 910, and one remaining (e.g., un-shot) metamorphic feature 908 within the body of multi-triggering symbol 906 (where five metamorphic features 908 are visually represented as having been shot (e.g., missing) from multi-triggering symbol 906 in connection with the five shot metamorphic features 908). FIG. 9G depicts a sixth metamorphic feature 908 being shot to metamorphic 904 as indicated by visual graphic 910, and no remaining (e.g., un-shot) metamorphic features 908 within the body of multi-triggering symbol 906 (where six metamorphic features 908 are visually represented as having been shot (e.g., missing) from multi-triggering symbol 906 in connection with the six shot metamorphic features 908). The shot metamorphic features 908 may be visually represented as missing within the body of multi-triggering symbol 906 in a variety of graphical manners, including but not limited an outline of the shape of the metamorphic features 908 that have been shot, a void where the un-shot metamorphic features 908 once resided, a grayed-out or faded representation of an un-shot metamorphic features 908, and so on and so forth, conveying to the user that the particular metamorphic feature(s) 908 has been shot (e.g., fired/dispensed). The order in which the various (e.g., first to sixth) metamorphic features 908 are shot, as represented in FIGS. 9B-9G, is non-limiting, and other firing sequences may be utilized. For example, in an alternative firing order, the (e.g., left) metamorphic feature 908 pointed at within multi-triggering symbol 906 in FIG. 9C could be fired before the (e.g., right) metamorphic feature 908 pointed at within multi-triggering symbol 906 in FIG. 9B.

Additionally, while not shown in FIGS. 9B-9G, metamorphic 904 may be depicted via visual graphics as visually filling-up with each successive hit from a shot metamorphic feature 908. For example, as with other embodiments (e.g., FIGS. 6E-6J), metamorphic graphics (e.g., such as 612/614/616 and/or 628/630/632) may be used to indicate metamorphic 904 as “filling” from left to right (e.g., gradually, from the “B” of “BONUS”, to the “O” of “BONUS”, and ultimately to the “S” of “BONUS” in metamorphic 904, depending on an outcome of the game) with each sequential hit from one or more shot metamorphic features 908 of any individual multi-triggering symbol 906 (e.g., before the feature game being triggered). Filling of metamorphic 904 may be visually represented by way of metamorphic graphics that change the appearance of metamorphic 904 to an activated color/pattern as compared to a base color/pattern of the body of metamorphic 904 (where the base color/pattern is used to represent the un-filled (e.g., non-activated) portion of metamorphic 904), and the color/pattern contrast between the activated color/pattern of the filled/activated body of metamorphic 904 and the base color/pattern of the non-activated (e.g., un-filled) portion functions as a visual progress bar to enable a user to visualize the amount metamorphic 904 has been hit and thereby “filled.” For example, upon adjustment of the metamorphic 904 by each metamorphic feature 908 that is shot, the individual letters of the word “BONUS” may appear in a highlight or accent color/pattern with each successive hit. That is, from left to right, the letters in the word “BONUS” become highlighted as more and more metamorphic features 908 land. Visually, this may be represented by the “B” in “BONUS” being highlighted in a bright orangish/yellow flame color and pattern, and then with each successive hit on metamorphic 904 from metamorphic features 908, the next letter(s) (e.g., “O” . . . “N” . . . “U” . . . . S″) become highlighted (whereas along the way to being completely filled, the portion of metamorphic 904 that has not yet been activated by a hit from metamorphic features 908 may appear as a blackened/dark pattern, such that the contract between the activated portion of metamorphic 904 is readily distinguished from the non-activated portion of metamorphic 904). For example, after 3 hits from metamorphic features 908, the letters “BON” may appear highlighted in a bright orangish/yellow flame color and pattern, whereas the letters “US” may appear in a blackened/dark pattern (indicating the metamorphic 904 has not yet been filled). The highlighting of each letter upon the various hits from metamorphic features 908 is only an example, and the portion(s) of metamorphic 904 that become activated from each hit may not always align with each letter (for example, each hit may cause activation (e.g., visual highlighting) of a portion of metamorphic 904 that lands between adjacent letters of the word “BONUS”, and/or that splits any individual letter (e.g., the “N” may have one half of the letter lit bright, and the other half of the letter dark)). Alternatively, metamorphic graphics such as flames may be used to indicate an amount which metamorphic 904 has become filled, where metamorphic 904 gradually (e.g., from left to right) becomes more and more engulfed in flames, indicating to a user that the metamorphic 904 is getting more and more filled and closer to a trigger state in which the feature game may be triggered by the filled metamorphic 904 according to feature game trigger rules as described herein (e.g., metamorphic 904 has been hit a sufficient amount of times from shot metamorphic features 908 to trigger the feature game). For example, when flame graphics are used, each letter of “BONUS” of metamorphic 904 may become engulfed in the flames, such that the individual letters disappear as the metamorphic 904 is filled (e.g., as flames engulf metamorphic 904 from left to right, the word “BONUS” changes to “ONUS” (“B” is engulfed), then to “NUS” (“BO” is engulfed), then to “US” (“BON” is engulfed), and finally just “S” (“BONU” is engulfed) before all letters of “BONUS” metamorphic 904 are engulfed, depending on the game outcome). These are only a few example options to visually represent the filling of metamorphic 904, and are not limiting. For example, a transition such as shown in FIGS. 6E-6G may also be utilized, where flames (e.g., similar to metamorphic graphics 612) may first appear at the bottom of metamorphic 904 and grow in height (e.g., similar to metamorphic graphics 614) with each hit from shot metamorphic features 908 until metamorphic 904 is fully engulfed (e.g. similar to metamorphic graphics 616), where the letters of “BONUS” become more and more covered (e.g., engulfed, from bottom to top) with each hit.

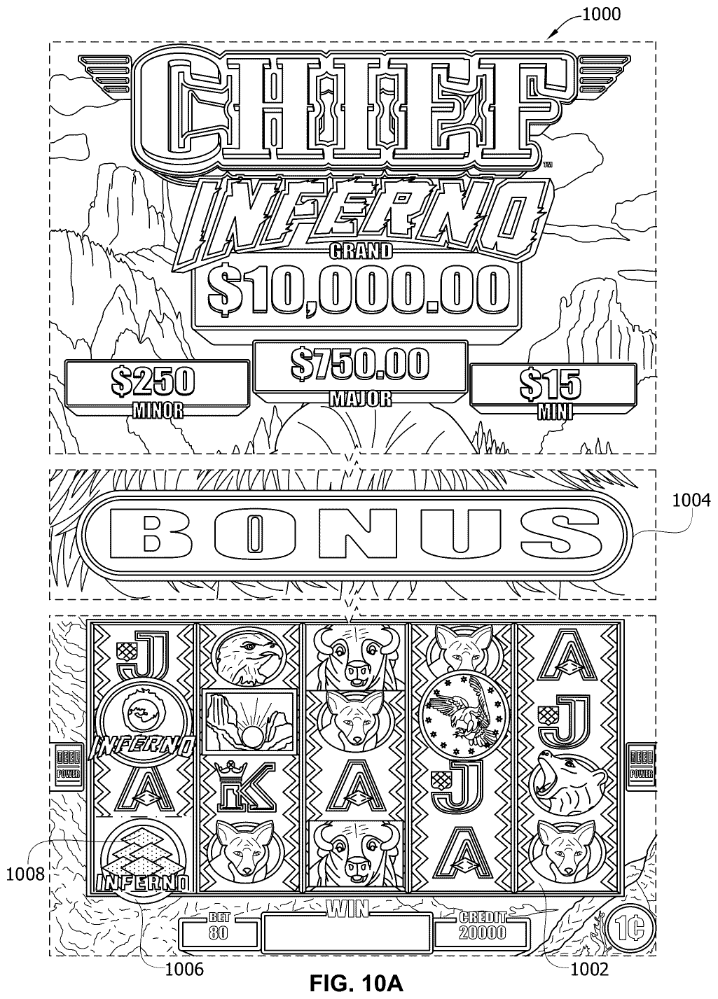

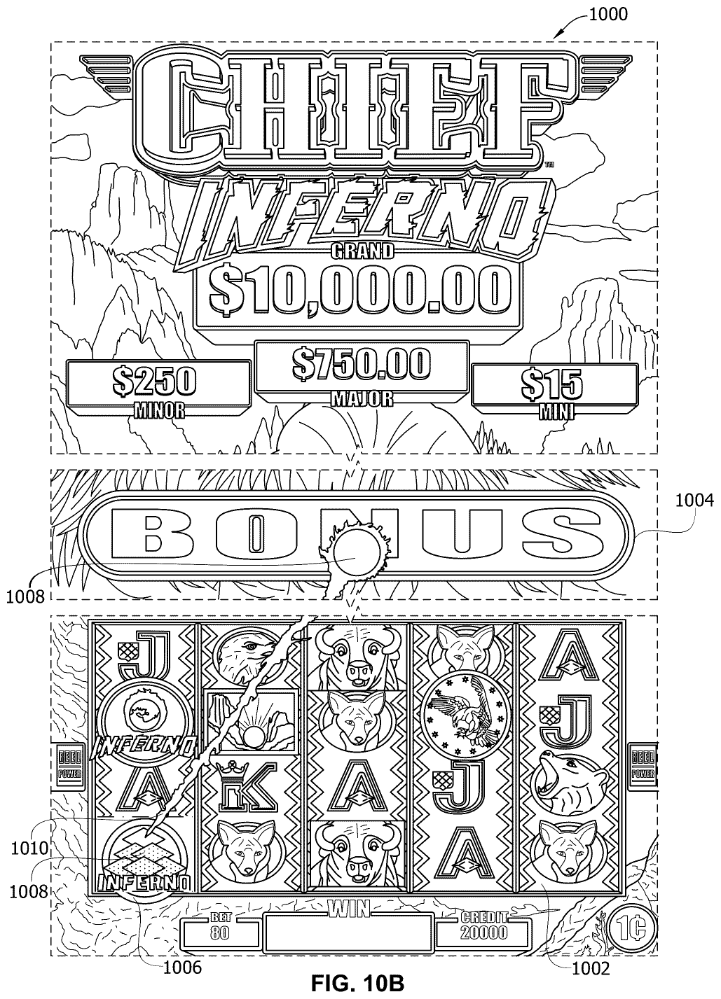

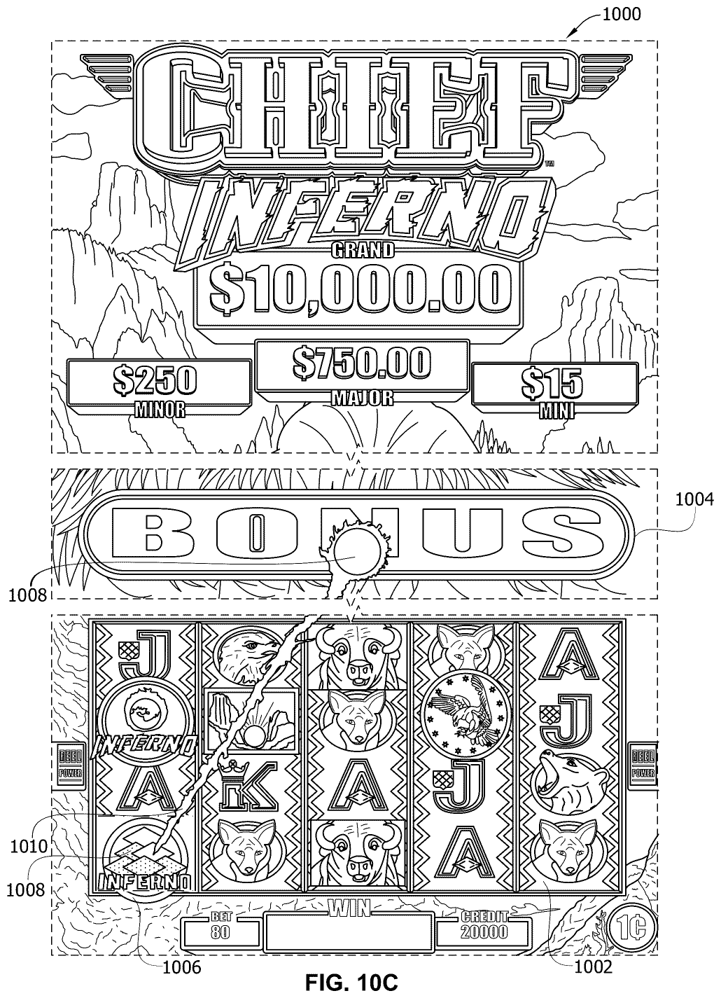

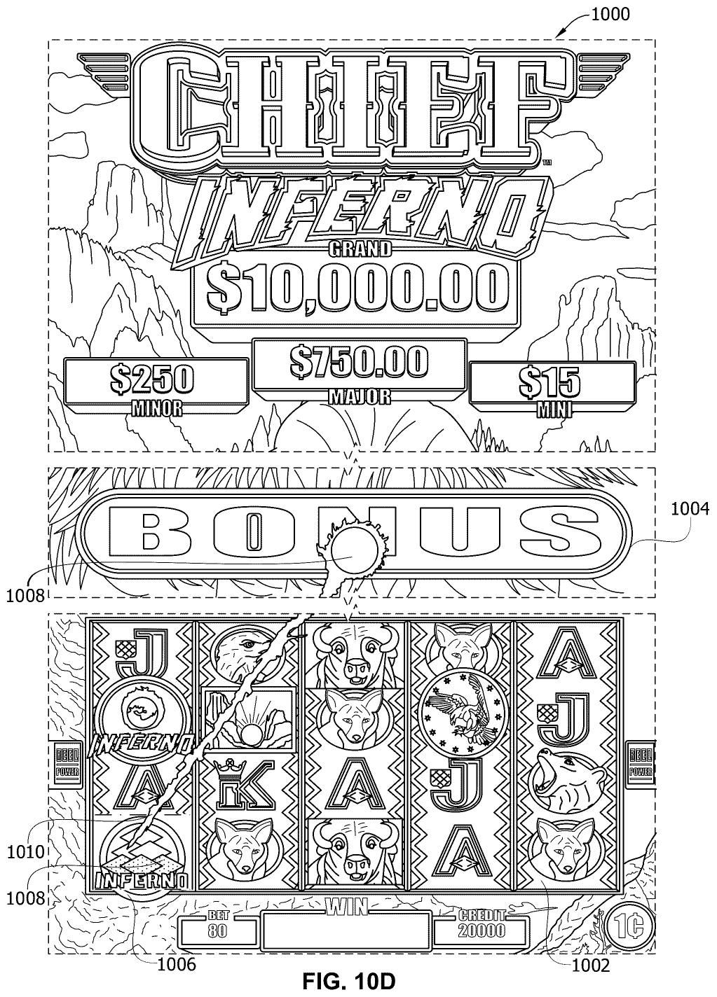

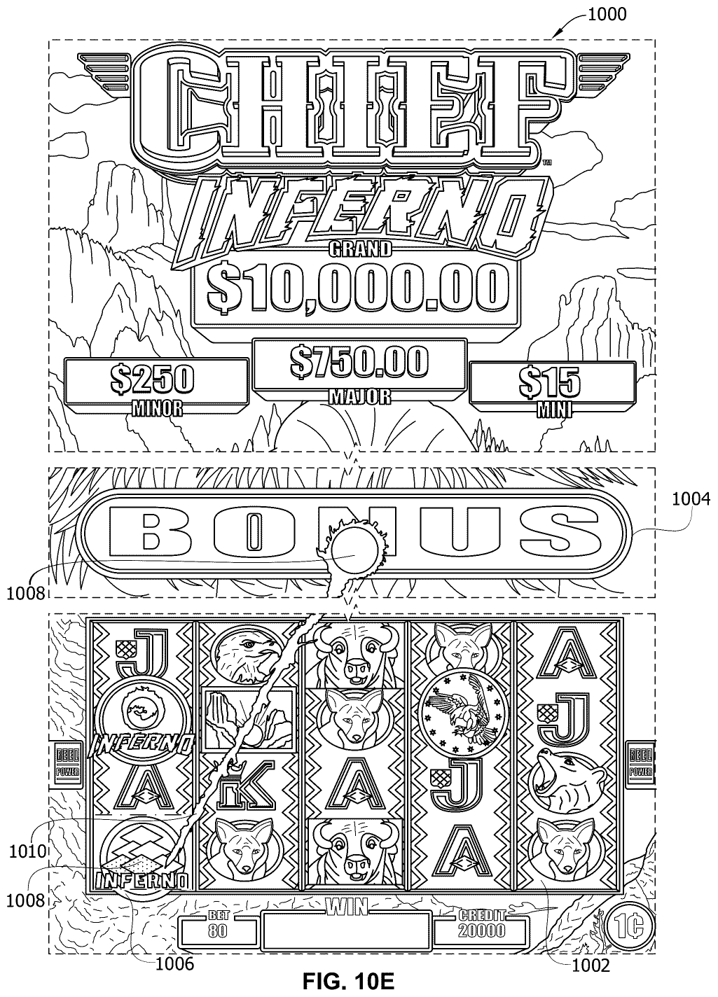

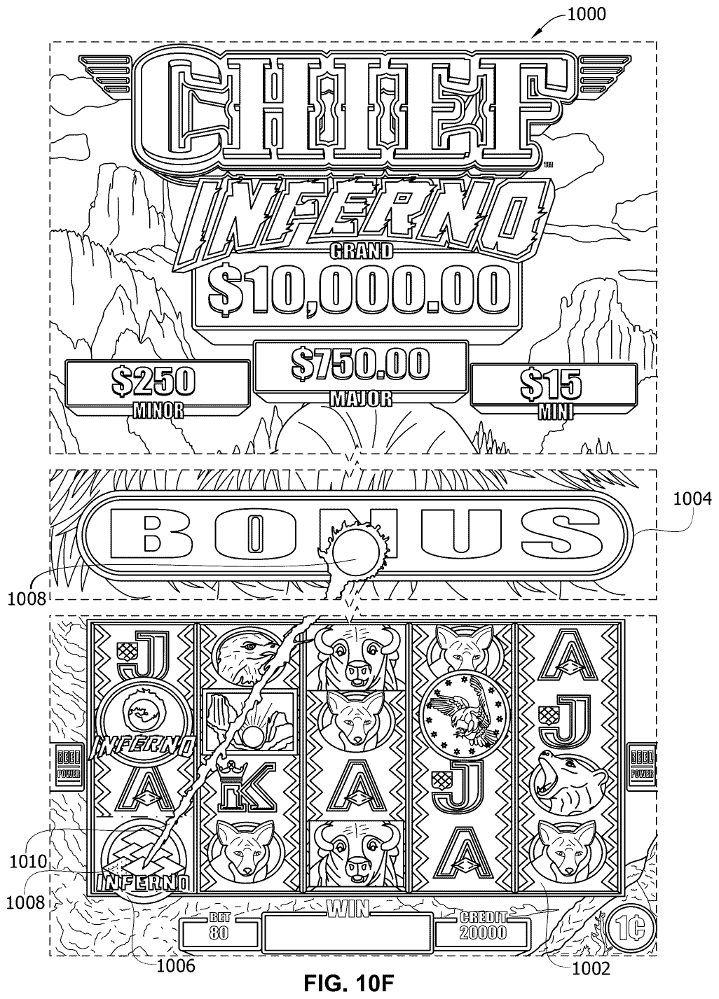

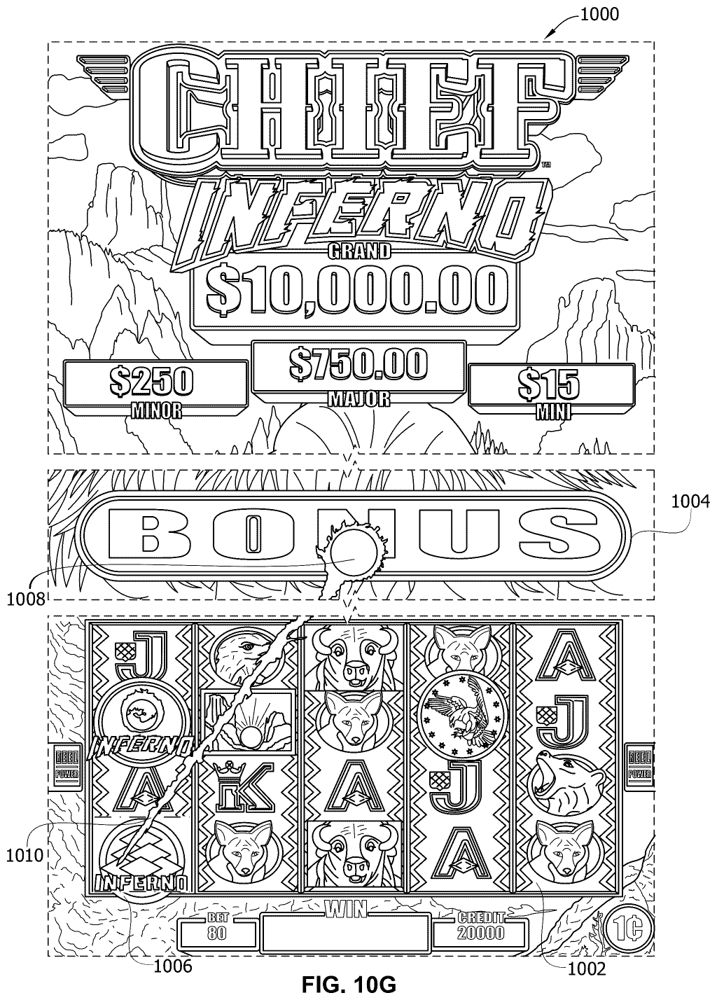

FIGS. 10A-10G depict another example game interface 1000, which may be displayed for example by gaming devices 104A-104X and/or mobile gaming devices 256 while performing process 400 and/or process 500, and has reels that are generally the same as or similar to those of game interface 900 (described above, for example), except for any differences described below. In the exemplary embodiment, game interface 1000 includes: (i) a set of reels 1002 (which is the same as or similar to reels 902, described above, for example) for the base game; (ii) at least one metamorphic 1004 (which is the same as or similar to metamorphic 904, described above, for example); (iii) one or more multi-triggering symbols 1006 (which is/are similar to multi-triggering symbols 906, described above, for example) associated with metamorphic 1004, and (iv) individual alternative metamorphic features 1008 (which is/are similar to metamorphic features 908, described above, for example, except that metamorphic features 1008 are alternative metamorphic features that have a different shape/appearance than metamorphic features 908) within a multi-triggering symbol 1006. Metamorphic features 1008 relate to triggering the metamorphic 1004 from the base game and/or modifying prize meters of the feature game once gaining access to the feature game (as described herein). Compared to the appearance/shape of metamorphic features 908, alternative metamorphic features 1008 may be depicted as a sideways diamond shape. In particular, FIGS. 10A-10G depict a firing sequence of a 6× embodiment of multi-triggering symbol 1006 (e.g., six alternative metamorphic features 1008 represented as miniature graphics within multi-triggering symbol 1006), where multi-triggering symbol 1006 may also include a 1× or 8× embodiment (for example as described herein in connection with 1× and 8× embodiments of other multi-triggering symbols).

FIGS. 10A-10G depict the same or similar firing sequence described above in connection with FIGS. 9A-9G, for example, except relative to the six alternative metamorphic features 1008 and their shape. Additionally, while not shown in FIGS. 10B-10G, metamorphic 1004 may be depicted via visual graphics as visually filling-up with each successive hit from a shot alternative metamorphic feature 1008 in the same or similar manner as described above in connection with metamorphic 904 and metamorphic features 908, for example.

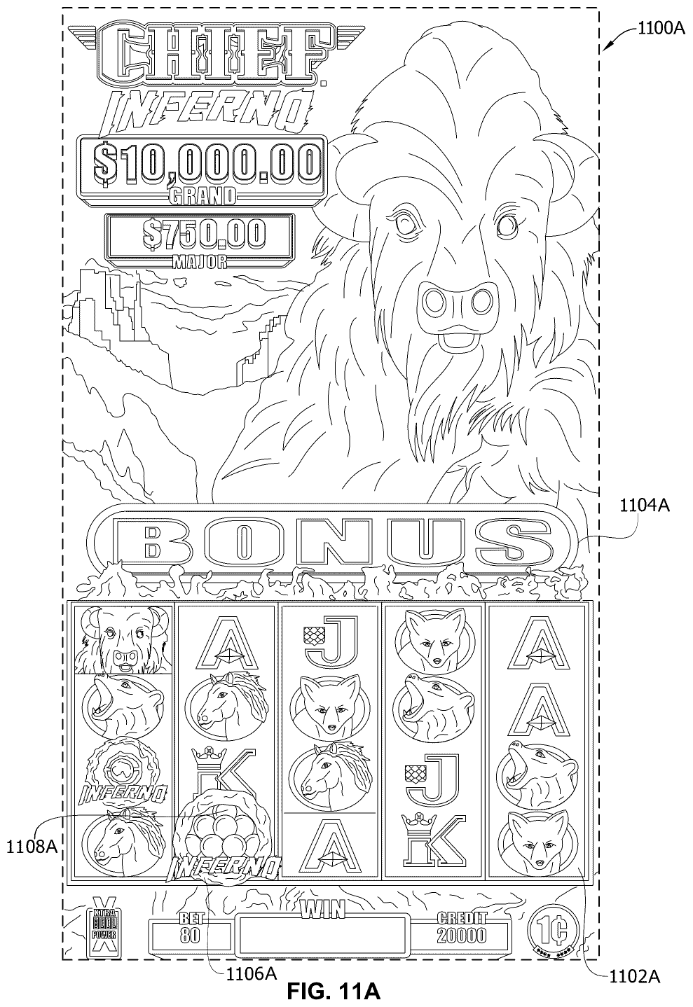

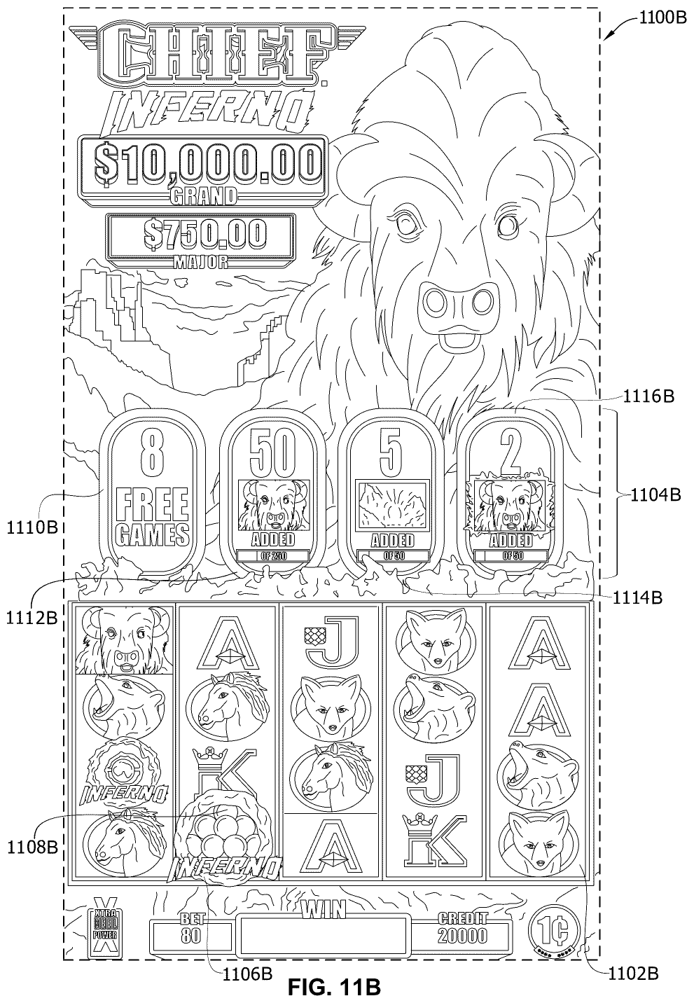

FIGS. 11A and 11B depict additional example game interfaces 1100A (FIG. 11A) and 1100B (FIG. 11B), which may be displayed for example by gaming devices 104A-104X and/or mobile gaming devices 256 while performing process 400 and/or process 500, and where interface 1100A is generally similar to game interfaces 900/1000 (described above, for example, except for any differences described below), and interface 1100B is generally similar to game interface 600 (described above, and as shown in FIGS. 6H-6L, for example, and except for any differences described below). More specifically, FIG. 11A depicts a base game interface 1100A, and FIG. 11B depicts a feature game interface 1100B.

Regarding FIG. 11A, in the exemplary embodiment, base game interface 1100A includes: (i) a set of reels 1102A (which is the same as or similar to reels 902/1002, described above, for example); (ii) at least one metamorphic 1104A (which is the same as or similar to metamorphic 904/1004, described above, for example); (iii) one or more multi-triggering symbols 1106A (which is/are similar to multi-triggering symbols 906/1006, described above, for example) associated with metamorphic 1104A; and (iv) individual metamorphic features 1108A (which is/are similar to metamorphic features 908, described above, for example) within multi-triggering symbol 1106A, and that relate to triggering the metamorphic 1104A from the base game and/or modifying prize meters of the feature game once gaining access to the feature game (as described herein). In particular, FIG. 11A depicts an 8× embodiment of multi-triggering symbol 1106A (e.g., eight metamorphic features 1108A represented as miniature graphics within multi-triggering symbol 1106A), where multi-triggering symbol 1106A and metamorphic features 1108A of FIG. 11A are similar to multi-triggering symbol 606 and metamorphic features 608, respectively, shown in FIGS. 6C and 6D, for example.

Regarding FIG. 11B, in the exemplary embodiment, feature game interface 1100B includes: (i) a set of reels 1102B (which is the same as or similar to reels 902/1002, described above, for example); (ii) a plurality of prize meters 1104B (which is/are the same as or similar to prize meters 618, 620, 622, 624 shown in FIGS. 6H-6L, described above, for example); (iii) one or more multi-triggering symbols 1106B (which is/are similar to multi-triggering symbols 906/1006, described above, for example); and (iv) individual metamorphic features 1108B (which is/are similar to metamorphic features 908, described above, for example) within multi-triggering symbol 1106B, and that relate to modifying prize meters 1104B, where prize meters 1104B include prize meters 1110B, 1112B, 1114B, and 1116B (which is/are similar to prize meters 618, 620, 622, 624, respectively, shown in FIGS. 6J and 6K, for example) of the feature game (as described herein). In particular, FIG. 11B depicts an 8× embodiment of multi-triggering symbol 1106 (e.g., eight metamorphic features 1008 represented as miniature graphics within multi-triggering symbol 1106), where the embodiment shown in FIG. 11B is similar to multi-triggering symbol 606 and metamorphic features 608 shown in FIG. 6K, for example. The shot metamorphic features 1108 may randomly (and in accordance with any rules relating to prize meters 1110B, 1112B, 1114B, and 1116B), hit any one or more of prize meters 1110B, 1112B, 1114B, and 1116B to increase (e.g., adjust) prize meters 1110B, 1112B, 1114B, and 1116B to different thresholds and arrive at adjusted prize meters 1110B, 1112B, 1114B, and 1116B, as described herein in connection with FIG. 6K, for example. Not shown in FIGS. 11A and 11B is any transition graphics and/or animation that may appear when metamorphic 1104A changes to the plurality of prize meters 1104B. In this regard, FIGS. 6H-6J depict example transition graphics that may appear when the base game transitions to the feature game and that may be used in conjunction with the transition between interfaces 1100A and 1100B, where other transition graphics/animations consistent with those described herein may also or alternatively be utilized.

As with the embodiments represented by and described in connection with FIGS. 6A-6L and 7A-7G, a reel set for the feature game is generated based upon the plurality of meters as adjusted (e.g., 618/620/622/624 (FIGS. 6K, 6L); 1110B/1112B/1114B/1116B (FIG. 11B)), the reel set in the feature game includes a plurality of symbols that are determined at least in part based on a final state of the adjusted plurality of meters (as well as being determined based on any applicable rules as described herein), and the feature game is initiated using the generated reel set.

Provided below are other aspects of the overall systems, methods, and techniques disclosed herein.

An example embodiment of base game mechanics is provided below. The base game may include a 4×5 reel matrix (see configuration of reels 602/702), and can include additional reel features such as a feature that allows a user to add more reels to the base reel matrix (e.g., an e.g., “Xtra Reel Power” feature as provided by extra reels feature 626, where the maximum numbers of reels is the sum of the reels in the base game reel matrix plus any additional number of reels permitted to be added by the “Xtra Reel Power” feature). The credit playing options and multipliers may include 1×=75 credits, 2×=200 credits, 3×=300 credits, 5×=500 credits, and 8×=800 credits, where certain multipliers are available at certain play levels (e.g., [1×, 2×, 3×, 5×, 8×] at a first (lowest) play level, [1×, 2×, 3×, 5×, 8×] at a second play level higher than the first play level, [1×, 2×, 3×, 5×, 8×] at third play level higher than each of the first and second play levels, and [1×, 2×, 3×, 5×] at a last (highest) play level, the last (highest) play level being higher than each of the first, second, and third play levels).

The base game operates according to a set of base game rules. For example, all reel power wins begin with the leftmost reel and pay left to right only on adjacent reels, except for wins such as “scatter” wins. The highest win is on an only per symbol basis. Coinciding wins are added. There may be wild symbols for all symbols (except metamorphic trigger symbols), and such wild symbols may only appear certain reels, such as only on the second, third, and/or fourth reels. Metamorphic trigger symbols (e.g., 606) can include variations as disclosed herein (e.g., one, six, or eight available fireballs, where the 6× fireball version replaces the 8× fireball version if a minimum credit play).

The base game may include 1× level fireball symbols as well as various dynamic fireball symbols for multi-triggering symbol 606, as defined by the system for the base game. For example, each reel set of the five total reels may include a specific lookup for a multi-triggering symbol 606 associated with each reel set, to populate the reel sets with the proper multi-triggering symbol 606. For each spin, one check is made to a lookup table, such as a table prescribing selection of a reel fireball symbol. This result then instructs as to which two reels may replace a 1× fireball symbol with a (dynamic) 6×- or 8×-fireball symbol. The multi-fireball (e.g., 6×, 8×) symbols may only be available at certain multiplier levels. For example, the 6× symbol at minimum credit level play, and the 8× symbol at all other play multipliers. The remaining (e.g., three) reels may replace a dynamic fireball symbol with a 1× fireball symbol consistent with permissible amounts/types of fireball symbols as disclosed herein.

An example of metamorphic triggering in the base game is provided below. The 1×, 6×, and 8× fireball types may make 1, 6 or 8 individual metamorphic trigger checks respectively. For the first metamorphic check, each spin may use a lookup table, such as a tables for metamorphic triggering, with a “True” marker being a feature trigger and “False” marker being a no feature trigger. The first metamorphic check may use a first metamorphic trigger table. For the second metamorphic check, each spin may use a first metamorphic trigger table, with that same logic. This is repeated up to a certain amount, such as a possible nineteenth check using a nineteenth metamorphic trigger table. Each check will shoot an animation up to metamorphic 604 (e.g., a Bonus meter). Metamorphic 604 will increase and animate with each hit. The fireball symbols will animate as each of their trigger checks are used (with a visible reduction in the number of their individual fireballs remaining). All reels to the right of an active fireball check are held spinning until that reel's checks are complete. If a “True” metamorphic trigger is determined, then the metamorphic 604 (e.g., Bonus meter) animates to full and sound and celebration graphics and/animations are played. The metamorphic 604 (e.g., Bonus meter) may be replaced by the four feature game meters (e.g., prize meters 618, 620, 622, 624). Prize meters 618, 620, 622, 624 may be carried over from the base game to free games. Reels spinning to the right of the reel that triggered the feature will remain spinning during this transition. Any remaining fireballs on either the triggering fireball symbol or subsequent fireball symbols to land will shoot up randomly to one of the four meters (e.g., prize meters 618, 620, 622, 624). This is the trigger phase. The four prize meters may start out with: 8 Free Games, 0 (blank) for the feature symbol, 0 (blank) for the wild symbol, and MINI unlocked. A prize trigger lookup table may be used to determine which prize meter will get an increase from each fireball (e.g., check once per each fireball remaining after trigger). This table is sample without replacement. This table may not be used at all during the free games feature. A “SPINS” result may check a prize spins lookup table to determine if 2, 3 or 5 free games are added. A “FEATURE SYMBOL” result may check a feature symbol lookup table to determine if 20, 25, or 50 feature symbols are added. This table is sample without replacement. This table is used during the free games feature of the feature game, and the replacement status of this table will be maintained into and during the entire free games feature. A “WILD” result will check a wild lookup table to determine the number of wild symbols to be added. For example, a certain number of wild symbols (e.g., 10 wild symbols) may always be added, but the wild lookup table is being included for consistency and modifiability. This table is also sample without replacement. A “JACKPOT” result will increase the level of jackpots unlocked for the entirety of the feature. First increase to MINI/MINOR, then MINI/MINOR/MAJOR, then MINI/MINOR/MAJOR/GRAND, with the value of the jackpot increasing at each level. For example, the MINI and MINOR jackpots may be fixed prizes that are available based on the number of credits played and any associated credit multipliers (e.g., MINI: 500, 1000, 1500, 2500, 4000 credits at 1×, 2×, 3×, 5×, and 8× credit multipliers; MINOR: 2500, 5000, 7500, 12500, 20000 credits at 1×, 2×, 3×, 5×, and 8× credit multipliers).

Additional operational aspects of the various embodiments disclosed herein are disclosed below. There may be a message such as “Press Play to Start” that appears after the transition into the free games feature. The EGM may wait for player to press/touch a button (e.g., “SPIN”) to start the free games feature. Each Free Spin plays automatically. A “Bonus Reels in Play” message may be displayed during such feature. A wild symbol that lands on a spin with a potential winning combination may expand to fill the reel. Wild multipliers may behave exactly like feature symbol multipliers. Wild multipliers may merge into feature symbol multipliers if they occur on the reel immediately to the right of a feature symbol multiplier (e.g., if it would have merged into the existing feature symbol multiplier were it a feature symbol stack, then it will merge into the feature symbols). The merged feature symbol/wild stack may look exactly like a normal feature symbol merge. A tall wild symbol substitutes for all symbols except scatters and acts as a single symbol on its reels for “Xtra Reel Power” win calculations. Non-adjacent tall wild symbols may not be merged but still have their multipliers combined as a product when calculating wins. A wild symbol on the fourth reel may multiply two of a kind pays. A wild symbol may not multiply credit wins from scatters. Free games may be played at the same Bet Multiplier as the triggering spin. Feature symbol stacks may function the same in free games as they do during the base game. There may be a splash screen showing the total feature win. There may be a transition animation such as an animal herd running down the reels. There may be a transition back to a lone feature symbol image in the top screen.

Feature symbol and wild symbol added logic is described below in connection with the free games feature of the feature game. Reel strip replacement status from lookup tables may be maintained into and during the entire free games feature. When all reels have stopped and all fireball symbols have increased prize meters, there may be a transition to the free games feature. The free games prize meter may be changed to a spin counter, and the jackpot prize meter may be changed to only display the unlocked jackpots.

An example embodiment of feature game mechanics is provided below. In the free games feature of the feature game, the user may be prompted to “Press Play” to start the feature. If any feature symbol was added during the trigger phase, a feature symbol burst animation may be played over the reels once they start spinning. If any wild symbols were added during the trigger phase, a wild burst animation may be played. If both were added, the combined burst animation may be played. All reels may be held spinning longer until this animation completes. If feature and wild symbols were added, reel strip modifications made during the trigger phase and during the feature may be cumulative throughout the feature (main and wild symbol substitutions made to the strips may persist for the duration of the current feature). Each new feature may start out with a clean copy of the free game reel strips. Feature and wild symbols added may be substitutions made for other symbols (e.g., animals and royals only) at pre-defined locations on the strips.

A variety of lookup tables give the locations for all possible 250 feature symbols added among each reels (reel indices starting with 0). These lookup tables may include specified feature symbols parameters regarding the order to distribute the added feature symbols. For each incremental amount of 5 feature symbols added, a check of the next row of to find the reel numbers for those next 5 feature symbol to be added may be performed. Beginning at the first entry in that table and increasing the entry number for each of the 5 feature symbols added throughout the feature. For example, the first entry may be “2, 2, 1, 0, 0”, indicating to add two feature symbols to the first reel, two feature symbols to the second reel, one feature symbol to third reel, and 0 feature symbol to the fourth and fifth reels. Replacement of the symbols with feature symbols at the positions indicated in the appropriate lookup table may be performed. For each replacement, the index used in that table for the next replacement position is increased. These positions markers for each of the five tables are kept running throughout the entire feature. This same logic is used for adding wild symbols, using appropriate lookup tables. Wild symbols may only ever be added to the second, third, and fourth reels.

Free game reel strips contain calls to dynamic coins (e.g., symbol 642) on the first through fifth reels, (although some may only be permitted on the first reel). For each spin check for a coin type, the result determines if that dynamic symbol will be a regular coin or supercoin. If a supercoin, a check of a super coin prize lookup may be needed to get the type of supercoin. If the result is “Spins,” a check may be performed for prize spins for the number of “Plus Spins” to display on that supercoin. If the result is adding feature symbols, then a feature symbol table may be used (the table being sample without replacement table (as previously described) to determine the number of feature symbols added to display on that supercoin. If the result is wild symbols added, then use a wild add table sample without replacement table and display the “Wild Added”’ on the supercoin may be used. If the Feature symbol Added or Wild Added SuperCoins are not awarded that spin, then their sample without replacement table does not have those entries discarded. There can only be a maximum of 9 Feature symbol Added and 5 Wild Added SuperCoin wins. Once that maximum is awarded, all subsequently dynamically determined SuperCoins of that type will instead be replaced with normal Coin. For example, for the first reel, this includes checking the appropriate table corresponding to the credits played and number of jackpot unlocks resulting from the trigger phase to determine the dynamic replacement. For example, a coin select table would be used when only MINI was unlocked and the credits played were 1× at first (lowest) play level.

An example retriggering mechanic in the free games feature is provided below. When two or more coins or supercoins of any type appear in any position on a spin, all supercoin prizes showing on the reels may be awarded. At the conclusion of the retriggering spin, the retrigger banner may be shown first. Coin totals of certain amounts may retrigger a certain number of free games. When a banner relating to this aspect is removed, each supercoin may be awarded from left to right. Jackpots awarded may get an individual win banner and celebration, with the other supercoins increasing their respective prize meters. Once all supercoin prizes are awarded (and wins shown), the next spin may start automatically. As disclosed, if any feature symbols were added during the trigger phase, a feature symbol burst animation may be played over the reels once they start spinning. If any wild symbols were added during the trigger phase, a wild burst animation may be played. If both were added, the combined burst animation is played. All reels may be held spinning longer until this animation completes.

An example outro from the free games feature is provided below. When all free games are completed, a win banner may be shown with the final feature award. There may be different levels of celebration graphics and/or animations. The reels will clear and revert to showing the triggering base game spin. The metamorphic 604 (e.g., Bonus meter, at minimum level) may replace the prize meters (e.g., 618, 620, 622, 624).

Additional aspects of the play cabinet of gaming device 104A are described below. Buttons of the cabinet may be physical or digital (e.g., virtual). For example, a virtual button deck may be provided via a touchscreen for the user to interact with. Buttons including but not limited to any bet button(s), play button(s), service button(s), a large “SPIN” button, and/or “cash out” button(s) appear on the virtual button deck. Messages such as indicating certain features being available may also appear on the virtual button deck. For example, a message such as “6× fireball available” may appear on the virtual button deck above a certain bet button (e.g., the bet 1× button), whereas a message such as “8× fireball available” may appear on the virtual button deck above all other bet buttons. All reels may be stopped ahead of the normal play time by pushing the large SPIN button, except during certain feature or anticipation events. Such a virtual button deck may also be utilized in non-cabinet embodiments of the game, such as in mobile gaming embodiments.

Additional aspects of the graphics and animations are disclosed below. Feature symbol, tall feature symbol, wild, tall wild symbol, and all coin symbols involved in winning combinations may continuously animate, while other symbols involved in winning combinations may cycle their win animations as a “Ways to win” message is displayed.

Additional aspects of anticipation gameplay mechanics are disclosed below. Regarding scatter anticipation (for the base game), once the metamorphic feature has triggered, all remaining reels may get an anticipation effect. This anticipation may extend each reel spin for a certain amount of time, such as two seconds. A subtle flame effect may be on the reel, and special audio (e.g., hooves sound). For free games, once the first scatter coin has landed on any of the first through fourth reels, all remaining reels may get an anticipation effect. The standard anticipation effect may extend that reel spin and play the anticipation sound effect. No additional graphic effect may be used. Regarding reel stack anticipation, whenever there two or more full stack multiplier symbols (feature symbol or wild) have landed in a winning combination, and a spinning reel can potentially continue that win if it lands another full stack, then a “Reel Stack Anticipation” routine for that reel can be run. If a full stack multiplier lands on anticipation, play the hit sound and effect. If the anticipated reel lands on a single/double/triple feature symbol that continues the win then the hit sound and effect is played. The “Reel Stack Anticipation” routine may extend the reel spin, play the anticipation sound effect, and play a special graphic anticipation effect on the reel.

Additional aspects of win messaging, win celebrations, and credit display are disclosed below. “Xtra Reel Power” wins may be defined according to standard and tall symbols and various multipliers feature symbol. Regarding win celebrations, a Win Meter may be blank when the win is zero credits. Multiple wins may be added to display a single number in the Win Meter. A CREDIT window may increase by the Win Meter's value when the win is complete.

Additional operational aspects are disclosed below. For “cash in,” certain (e.g., standard audio) may play on “cash in.” Custom audio may be used throughout the game. This may include voiceovers and other audible features directed, for example, to feature aspects. For example, there may be one or more levels of a shout of a main character of the game. Thresholds for a win amount containing a feature symbol win may determine which (if any) is played. In an idle state, an attract mode may be displayed on the display of game device 104A, where certain messages (e.g., attract messages) may cycle through during the idle state. Reset positions are a non-winning combination on all possible permutations and for all variations.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system for electronic gaming comprising:
at least one memory device storing instructions; and
at least one processor in communication with the at least one memory device, wherein the instructions, when executed by the at least one processor, cause the at least one processor to:
cause display of a plurality of symbols for a play of an electronic game, the plurality of symbols including at least one multi-triggering symbol associated with a plurality of chances to trigger a feature game;
randomly determine that one chance of the plurality of chances causes the feature game to be triggered;
cause display of a plurality of meters for the feature game based upon the one chance causing the feature game to be triggered;
for each remaining chance of the plurality of chances, cause a meter of the plurality of meters for the feature game to increase resulting in an adjusted plurality of meters;
generate a reel set for the feature game based upon the adjusted plurality of meters, the reel set including a plurality of reels each including a plurality of symbols that are determined at least in part based on a final state of the adjusted plurality of meters; and
cause the feature game to be initiated using the generated reel set.

2. The system of claim 1, wherein the plurality of meters comprises at least four meters, the at least four meters comprising (i) a free games meter, (ii) a feature symbol meter, (iii) a wild symbol meter, and (iv) a jackpot meter.

3. The system of claim 2, wherein an increase of the jackpot meter comprises unlocking at least one of a mini jackpot, a minor jackpot, a major jackpot, or a grand jackpot as being eligible to be provided in the feature game.

4. The system of claim 2, wherein an increase of the free games meter causes an additional play of the feature game to be provided.

5. The system of claim 2, wherein an increase of the feature symbol meter causes one or more additional feature symbols to be included on the reel set at one or more first predetermined symbol positions.

6. The system of claim 5, wherein an increase of the wild symbol meter causes one or more wild symbols to be included on the reel set at one or more second predetermined symbol positions.

7. The system of claim 6, wherein the one or more first predetermined symbol positions and the one or more second predetermined symbol positions are selected to control return to player (RTP) of the feature game.

8. The system of claim 1, wherein the instructions further cause the at least one processor to cause display of a metamorphic graphic associated with triggering the feature game to be adjusted for each chance of the plurality of chances before the feature game is triggered.

9. The system of claim 1, wherein the at least one multi-triggering symbol comprises a plurality of metamorphic features corresponding to the plurality of chances to trigger the feature game, and each respective metamorphic feature of the plurality of metamorphic features corresponds to a respective chance of the plurality of chances to trigger the feature game.

10. The system of claim 9, wherein one or more first metamorphic features of the plurality of metamorphic features are associated with one or more chances to trigger the feature game, and one or more second metamorphic features of the plurality of metamorphic features are associated with one or more remaining chances to increase a meter of the plurality of meters, the one or more first metamorphic features being different than the one or more second metamorphic features.

11. A computer-implemented method for electronic gaming implemented using at least one memory device having instructions stored thereon and at least one processor in communication with the at least one memory device, the execution of the instructions causing the at least one processor to perform steps comprising:
causing display of a plurality of symbols for a play of an electronic game, the plurality of symbols including at least one multi-triggering symbol associated with a plurality of chances to trigger a feature game;
randomly determining that one chance of the plurality of chances causes the feature game to be triggered;
causing display of a plurality of meters for the feature game based upon the one chance causing the feature game to be triggered;
for each remaining chance of the plurality of chances, causing a meter of the plurality of meters for the feature game to increase resulting in an adjusted plurality of meters;
generating a reel set for the feature game based upon the adjusted plurality of meters, the reel set including a plurality of reels each including a plurality of symbols that are determined at least in part based on a final state of the adjusted plurality of meters; and
causing the feature game to be initiated using the generated reel set.

12. The method of claim 11, wherein the plurality of meters comprises at least four meters, the at least four meters comprising (i) a free games meter, (ii) a feature symbol meter, (iii) a wild symbol meter, and (iv) a jackpot meter.

13. The method of claim 11, further comprising displaying a metamorphic graphic associated with triggering the feature game to be adjusted for each chance of the plurality of chances before the feature game is triggered.

14. The method of claim 11, wherein the at least one multi-triggering symbol comprises a plurality of metamorphic features corresponding to the plurality of chances to trigger the feature game, and each respective metamorphic feature of the plurality of metamorphic features corresponds to a respective chance of the plurality of chances to trigger the feature game.

15. The method of claim 14, wherein one or more first metamorphic features of the plurality of metamorphic features are associated with one or more chances to trigger the feature game, and one or more second metamorphic features of the plurality of metamorphic features are associated with one or more remaining chances to increase a meter of the plurality of meters, the one or more first metamorphic features being different than the one or more second metamorphic features.

16. One or more non-transitory computer-readable storage media containing instructions thereon for controlling one or more electronic gaming devices, which when executed by one or more processors of the one or more electronic gaming devices, cause the one or more processors to: cause display of a plurality of symbols for a play of an electronic game, the plurality of symbols including at least one multi-triggering symbol associated with a plurality of chances to trigger a feature game;
randomly determine that one chance of the plurality of chances causes the feature game to be triggered;
cause display of a plurality of meters for the feature game based upon the one chance causing the feature game to be triggered;
for each remaining chance of the plurality of chances, cause a meter of the plurality of meters for the feature game to increase resulting in an adjusted plurality of meters;
generate a reel set for the feature game based upon the adjusted plurality of meters, the reel set including a plurality of reels each including a plurality of symbols that are determined at least in part based on a final state of the adjusted plurality of meters; and
cause the feature game to be initiated using the generated reel set.

17. The one or more non-transitory computer-readable storage claim 16, wherein the plurality of meters comprises at least four meters, the at least four meters comprising (i) a free games meter, (ii) a feature symbol meter, (iii) a wild symbol meter, and (iv) a jackpot meter.

18. The one or more non-transitory computer-readable storage media of claim 16, wherein execution by the one or more processors further causes display of a metamorphic graphic associated with triggering the feature game to be adjusted for each chance of the plurality of chances before the feature game is triggered.

19. The one or more non-transitory computer-readable storage media of claim 16, wherein the at least one multi-triggering symbol comprises a plurality of metamorphic features corresponding to the plurality of chances to trigger the feature game, and each respective metamorphic feature of the plurality of metamorphic features corresponds to a respective chance of the plurality of chances to trigger the feature game.

20. The one or more non-transitory computer-readable storage media of claim 19, wherein one or more first metamorphic features of the plurality of metamorphic features are associated with one or more chances to trigger the feature game, and one or more second metamorphic features of the plurality of metamorphic features are associated with one or more remaining chances to increase a meter of the plurality of meters, the one or more first metamorphic features being different than the one or more second metamorphic features.
